(19) United States
(12) Patent Application Publication
(10) Pub. No.: US 2019/0153319 A1
(43) Pub. Date: May 23, 2019

(54) LIQUID CRYSTAL DISPLAY DEVICE AND METHOD OF MANUFACTURING THE SAME

(71) Applicant: Samsung Display Co. Ltd., Yongin-si (KR)

(72) Inventors: Tae Hoon KIM, Suwon-si (KR); Won Gap YOON, Suwon-si (KR); Chang Hun LEE, Hwaseong-si (KR)

(21) Appl. No.: 16/192,638

(22) Filed: Nov. 15, 2018

(30) Foreign Application Priority Data
Nov. 17, 2017 (KR) 10-2017-0154043

(51) Int. Cl. C09K 19/56; G02F 1/1337

(52) U.S. Cl. CPC C09K 19/56; G02F 1/1368; G02F 2001/133773; G02F 1/133723

(57) ABSTRACT

Provided are a liquid-crystal display device and a method of manufacturing a liquid-crystal display device. The liquid-crystal display device includes a first base substrate, a first liquid crystal alignment layer disposed on the first base substrate. The first liquid crystal alignment layer includes a polyimide-based polymer and an organic-inorganic composite. A liquid crystal layer is disposed on the first liquid crystal alignment layer. A method of manufacturing a liquid-crystal display device includes forming a first liquid crystal alignment layer including a polyimide-based polymer and an organic-inorganic composite on a first base substrate and forming a liquid crystal layer on the first liquid crystal alignment layer.

### CROSS-REFERENCE TO RELATED APPLICATION

This application claims priority from and the benefit of Korean Patent Application No. 10-2017-0154043, filed on Nov. 17, 2017, which is hereby incorporated by reference for all purposes as if fully set forth herein.

### BACKGROUND

### Field

Exemplary embodiments of the invention relate generally to a liquid-crystal display device (LCD) and a method of manufacturing the same.

### Discussion of the Background

Display devices are becoming increasingly important with the development of multimedia. In response to this, various display devices, such as a liquid-crystal display device (LCD), an organic light-emitting diode (OLED) display, and the like, are being developed. For example, an LCD may control a polarization state of light transmitted through a liquid crystal layer by rearranging liquid crystals in the liquid crystal layer using an electric field formed between a pixel electrode and a common electrode. The liquid crystal layer may function as an optical shutter for adjusting an amount of light transmitted from a backlight unit along with two polarizing elements disposed on upper and lower portions of the liquid crystal layer. An image may be displayed by controlling an amount of light for each pixel transmitted through the liquid crystal layer.

In order for the liquid crystal layer to function as the optical shutter, the liquid crystals in the liquid crystal layer should be initially uniformly aligned. Uniformity of initial alignment of the liquid crystals is an important factor determining display quality of the LCD. As one method of initially aligning liquid crystals, a method using a liquid crystal alignment layer including a polyimide-based polymer may be exemplified.

The above information disclosed in this Background section is only for understanding of the background of the inventive concepts, and, therefore, it may contain information that does not constitute prior art.

### SUMMARY

A liquid crystal alignment layer is required to have excellent film hardness in addition to an alignment property of liquid crystals. When the film hardness of the liquid crystal alignment layer is insufficient, display quality defects, such as after-image defects, light leakage defects, or the like, may be caused while a liquid-crystal display device (LCD) is driven and a lifetime of the LCD may be shortened.

The liquid crystal alignment layer should be cured at a high temperature for a sufficient time in order for the liquid crystal alignment layer including a polyimide-based polymer to have sufficient film hardness. However, when a panel for manufacturing an LCD is exposed at a high temperature for a long time, there is a problem in that other components of the panel for manufacturing an LCD formed before the liquid crystal alignment layer are damaged.

Exemplary embodiments provide an LCD including a liquid crystal alignment layer having sufficient film hardness, thereby having excellent display quality and an improved lifetime characteristic.

Exemplary embodiments also provide a method of manufacturing an LCD in which a process is performed under a relatively low temperature condition so that a processability thereof is improved, damage to other components is prevented, and sufficient film hardness is imparted to a liquid crystal alignment layer.

Additional features of the inventive concepts will be set forth in the description which follows, and in part will be apparent from the description, or may be learned by practice of the inventive concepts.

An exemplary embodiment of the invention includes a liquid-crystal display device. The liquid-crystal display device includes a first base substrate, a first liquid crystal alignment layer disposed on the first base substrate. The first liquid crystal alignment layer includes a polyimide-based polymer and an organic-inorganic composite. A liquid crystal layer is disposed on the first liquid crystal alignment layer.

In an exemplary embodiment, the organic-inorganic composite may be organic-inorganic composite particles including a layered inorganic substance having a layered structure and an ammonium compound located between layers of the layered inorganic substance.

In an exemplary embodiment, the ammonium compound may include an alkyl ammonium salt represented by the following Chemical Formula 2,

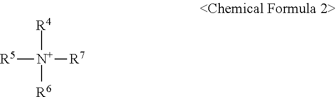

In the above Chemical Formula 2, each of R⁴ and R⁵ is hydrogen or a methyl group, R⁶ is hydrogen or a linear-chain or branched-chain alkyl group having a carbon number of 12 to 20, and R⁷ is a linear-chain or branched-chain alkyl group having a carbon number of 12 to 20.

In an exemplary embodiment, the alkyl ammonium salt represented by the above Chemical Formula 2 may include an alkyl ammonium salt represented by the following Chemical Formula 2A or an alkyl ammonium salt represented by the following Chemical Formula 2B; and a content of the alkyl ammonium salt represented by the following Chemical Formula 2A may be greater than a content of the alkyl ammonium salt represented by the following Chemical Formula 2B,

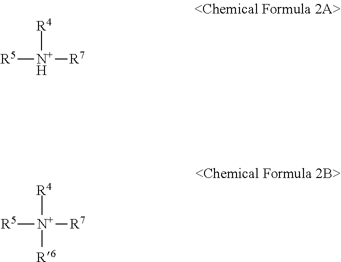

In the above Chemical Formula 2A and Chemical Formula 2B, R⁴, R⁵, and R⁷ are the same as those defined in the above Chemical Formula 2, and R′⁶ is a linear-chain or branched-chain alkyl group having a carbon number of 12 to 20.

In an exemplary embodiment, the alkyl ammonium salt represented by the above Chemical Formula 2 may include a tetradecyl ammonium salt in which R⁷ is a tetradecyl group, a hexadecyl ammonium salt in which R⁷ is a hexadecyl group, and an octadecyl ammonium salt in which R⁷ is an octadecyl group, and a content of the octadecyl ammonium salt may be greater than a sum of a content of the tetradecyl ammonium salt and a content of the hexadecyl ammonium salt.

In an exemplary embodiment, the polyimide-based polymer may include a main chain having a imide group and a vertically aligned side chain bonded to the main chain, and at least a part of the main chain of the polyimide-based polymer may be located between the layers of the layered inorganic substance.

In an exemplary embodiment, the ammonium compound may include alkyl ammonium; and at least a part of the polyimide-based polymer may form a structure entangled with an alkyl group of the alkyl ammonium.

In an exemplary embodiment, a content of the organic-inorganic composite in the first liquid crystal alignment layer may be partially non-uniform.

In an exemplary embodiment, the liquid-crystal display device may further comprise a common electrode disposed between the first base substrate and the first liquid crystal alignment layer, wherein the first liquid crystal alignment layer may include a first layer in contact with the common electrode and a second layer in contact with the liquid crystal layer, and a content of organic-inorganic composite in the first layer may be greater than a content of organic-inorganic composite in the second layer.

In an exemplary embodiment, the liquid-crystal display device may further include a second liquid crystal alignment layer disposed on the liquid crystal layer, a pixel electrode disposed on the second liquid crystal alignment layer; a second base substrate disposed on the pixel electrode, and a backlight unit disposed on the second base substrate. One surface of the second base substrate facing the backlight unit may be convexly bent. The second liquid crystal alignment layer may not include the organic-inorganic composite, or a content of organic-inorganic composite in the second liquid crystal alignment layer may be smaller than the content of the organic-inorganic composite in the first liquid crystal alignment layer.

An exemplary embodiment of the invention includes a method of manufacturing a liquid-crystal display device. The method of manufacturing a liquid-crystal display device, the method includes forming a first liquid crystal alignment layer including a polyimide-based polymer and an organic-inorganic composite on a first base substrate, and forming a liquid crystal layer on the first liquid crystal alignment layer.

In an exemplary embodiment, the organic-inorganic composite may be organic-inorganic composite particles including a layered inorganic substance having a layered structure and an ammonium compound located between layers of the layered inorganic substance.

In an exemplary embodiment, the forming of the first liquid crystal alignment layer may include applying a liquid crystal alignment agent composition to the first base substrate, and baking the liquid crystal alignment agent composition at a temperature of 160° C. to 180° C.

In an exemplary embodiment, the liquid crystal alignment agent composition may include a polyamic acid or a polyimide, and the organic-inorganic composite particles.

In an exemplary embodiment, in the baking of the liquid crystal alignment agent composition, at least a part of the polyamic acid may be dehydrated and cyclized to form a polyimide-based polymer; and in the baking of the liquid crystal alignment agent composition, at least a part of a main chain of the polyimide-based polymer may be inserted between the layers of the layered inorganic substance and stabilized.

In an exemplary embodiment, a content of the organic-inorganic composite particles may range from 0.1 wt % to 2.0 wt % with respect to a total weight of the liquid crystal alignment agent composition.

In an exemplary embodiment, in the baking of the liquid crystal alignment agent composition, the liquid crystal alignment agent composition may be phase-separated into a first layer including the organic-inorganic composite particles and a second layer disposed on the first layer and having a smaller content of organic-inorganic composite particles than the first layer.

In an exemplary embodiment, the method may further include, after the forming of the liquid crystal layer, a first exposure operation of emitting ultraviolet rays to the liquid crystal layer in a state in which an electric field is formed in the liquid crystal layer, and a second exposure operation of emitting ultraviolet rays to the liquid crystal layer in a state in which an electric field is not formed in the liquid crystal layer.

In an exemplary embodiment, the method may further include, before the forming of the liquid crystal layer, preparing a second base substrate, and forming a second liquid crystal alignment layer including a polyimide-based polymer on the second base substrate, wherein the forming of the liquid crystal layer may be an operation of forming a liquid crystal layer between the first liquid crystal alignment layer and the second liquid crystal alignment layer.

In an exemplary embodiment, the second liquid crystal alignment layer may not include the organic-inorganic composite, or a content of organic-inorganic composite in the second liquid crystal alignment layer may be smaller than a content of the organic-inorganic composite in the first liquid crystal alignment layer.

In an exemplary embodiment, the method may further include convexly bending one surface of the first base substrate facing the second base substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is an exploded perspective view of a liquid-crystal display device (LCD) according to one exemplary embodiment of the invention.

FIG. 2 is a cross-sectional view illustrating arbitrary pixels of the LCD of FIG. 1.

FIG. 3 is an enlarged schematic view of area A of FIG. 2.

FIG. 4 is an enlarged schematic view of area B of FIG. 2.

FIG. 5 is a cross-sectional view of an LCD according to another exemplary embodiment.

FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, and FIG. 19 are views illustrating a method of manufacturing an LCD according to one exemplary embodiment.

FIG. 20, FIG. 21, FIG. 22, FIG. 23, FIG. 24, and FIG. 25 are views illustrating a method of manufacturing an LCD according to another exemplary embodiment.

FIG. 26A and FIG. 26B are images of a liquid crystal alignment layer according to Experimental Example 1.

### DETAILED DESCRIPTION OF THE EMBODIMENTS

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, exemplary embodiments will be described with reference to the accompanying drawings.

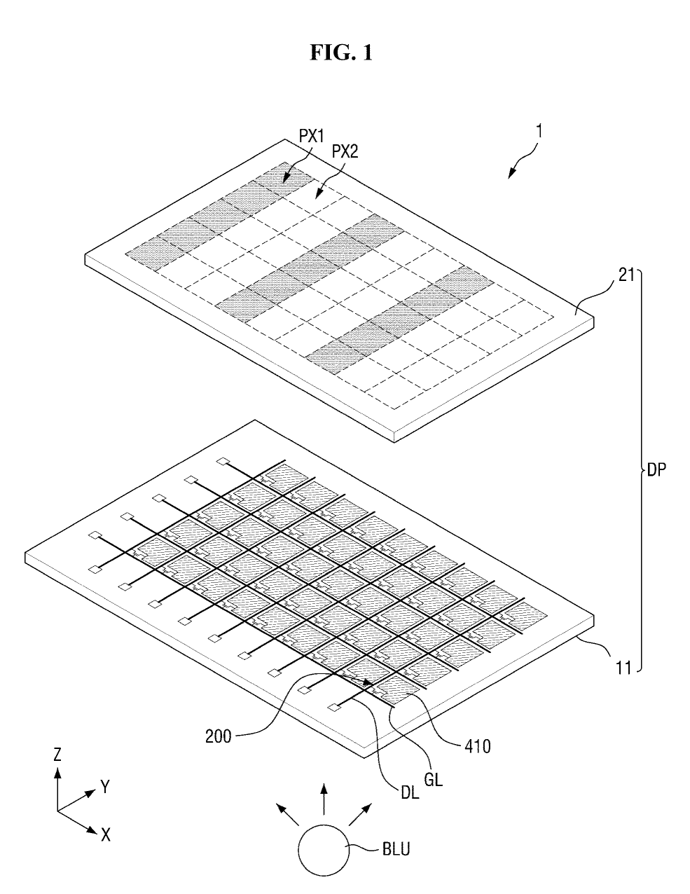

FIG. 1 is an exploded perspective view of a liquid-crystal display device (LCD) according to one exemplary embodiment.

Referring to FIG. 1, an LCD 1 according to the present exemplary embodiment may include a display panel DP and a backlight unit BLU providing light to the display panel DP.

A plurality of pixels PX1 and PX2 in the form of a matrix (or substantially a matrix) when viewed from above may be defined in the display panel DP. In this specification, the pixel refers to a single area in which a display area is divided and defined for color displaying when viewed from above, and one pixel may express one predetermined basic color. That is, one pixel may be a minimum unit area which may independently express a color from other pixels.

The plurality of pixels PX1 and PX2 may include first pixels PX1 for displaying a first color and second pixels PX2 for displaying a second color having a longer peak wavelength than the first color. In an exemplary embodiment, the first pixels PX1 and the second pixels PX2 may form at least a part of a repeating unit, and the repeating units may be arranged in a first direction X. For example, the first pixels PX1, the second pixels PX2, and third pixels, which are arranged in the first direction X and display different colors, may form one repeating unit, and the repeating unit may be repeatedly arranged in the first direction X. Further, the first pixels PX1 and the second pixels PX2 may be repeatedly arranged in a second direction Y. Hereinafter, an example of a case in which the first color displayed by the first pixels PX1 is blue having a peak wavelength of about 430 nanometers (nm) to 470 nm and the second color displayed by the second pixels PX2 is green having a peak wavelength of about 530 nm to 570 nm is described, but the present disclosure is not limited thereto. In another exemplary embodiment, the second color displayed by the second pixels PX2 may be red having a peak wavelength of about 610 nm to 650 nm.

The backlight unit BLU may be disposed below the display panel DP to emit light having a specific wavelength toward the display panel DP. Specifically, light provided by the backlight unit BLU may be sequentially transmitted through a lower polarizing element, a liquid crystal layer 31, and an upper polarizing element, and then may contribute to image display.

In an exemplary embodiment, the backlight unit BLU may be an edge type backlight unit including a light source which directly emits light and a light guide plate which guides light provided from the light source to emit the light toward the display panel DP. A material of the light guide plate is not particularly limited as long as it is a material having a high light transmittance. For example, the material of the light guide plate may include a glass material, quartz material, or plastic material such as polyethylene terephthalate, polycarbonate, or the like. In another exemplary embodiment, the backlight unit BLU may be a direct backlight unit including a direct light source.

The light source may be a light-emitting diode (LED), an organic light-emitting diode (OLED), a laser diode (LD), or the like. In an exemplary embodiment, the light source may emit blue light having a single peak wavelength of about 430 nm to 470 nm. In another exemplary embodiment, the light source may emit light in an ultraviolet wavelength band or emit white light.

Although not illustrated in the drawing, one or more optical sheets may be disposed between the display panel DP and the backlight unit BLU. The optical sheet may include at least one of a prism sheet, a diffusion sheet, a (reflective) polarizing sheet, a lenticular lens sheet, and a micro lens sheet. The optical sheet may improve display quality of the LCD 1 by modulating an optical characteristic, such as a condensing characteristic, a diffusion characteristic, a scattering characteristic, or a polarization characteristic, of the light which is provided from the backlight unit BLU toward the display panel DP.

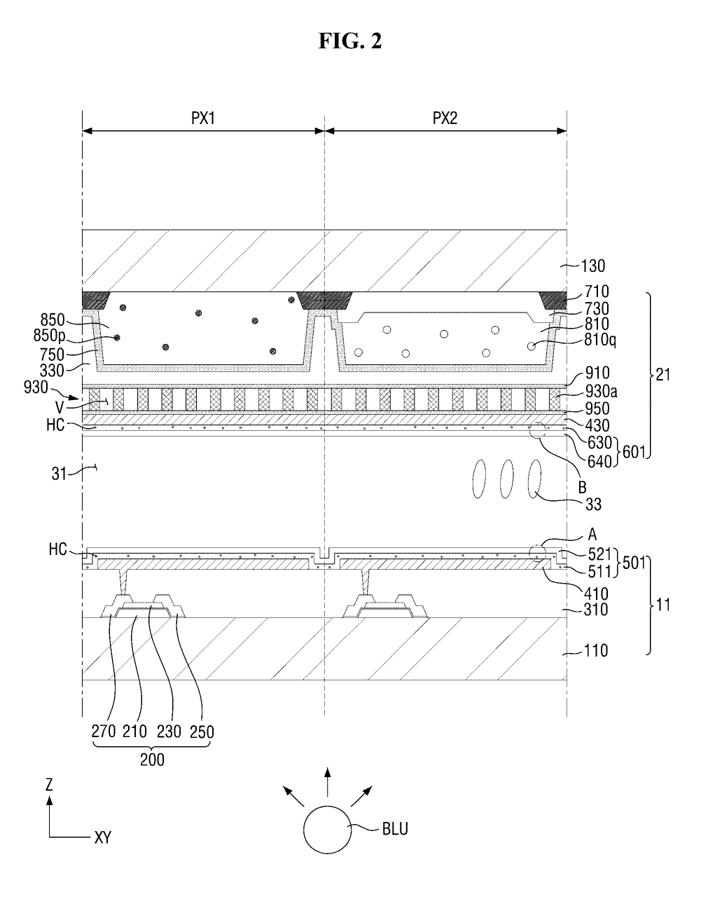

Hereinafter, the display panel DP will be described in detail with further reference to FIG. 2.

FIG. 2 is a cross-sectional view illustrating arbitrary pixels of the LCD of FIG. 1, and is a cross-sectional view illustrating the first pixel PX1 and the second pixel PX2 which express different colors.

Referring to FIGS. 1 and 2, the display panel DP may include a lower substrate 11, an upper substrate 21 opposite the lower substrate 11, and the liquid crystal layer 31 interposed therebetween. The liquid crystal layer 31 may be sealed by the lower substrate 11, the upper substrate 21, and a sealing member which bonds the lower substrate 11 and the upper substrate 21.

First, the lower substrate 11 will be described. The lower substrate 11 may include a lower base substrate 110, a switching element 200, and pixel electrodes 410 and may further include a lower liquid crystal alignment layer 501.

The lower base substrate 110 may be a transparent insulating substrate or a transparent insulating film. For example, the lower base substrate 110 may be made of a glass material, quartz material, or translucent plastic material. In some exemplary embodiments, the lower base substrate 110 may be flexible and the LCD 1 may be a curved display device. The backlight unit BLU may be disposed on a rear surface (a lower surface in FIG. 2) of the lower base substrate 110.

A plurality of switching elements 200 may be arranged on one surface (an upper surface in FIG. 2) of the lower base substrate 110. Each of the switching elements 200 may be arranged for each of the pixels PX1 and PX2 to transmit or block a driving signal to the pixel electrode 410 which will be described below. In an exemplary embodiment, the switching element 200 may be a thin film transistor including a gate 210, an active layer 230 disposed on the gate 210, and a drain 250 and a source 270 which are spaced apart from each other on the active layer 230. A control terminal (e.g., the gate 210) may be electrically connected to a gate line GL to receive a gate driving signal, an input terminal (e.g., the drain 250) may be electrically connected to a data line DL to receive a data driving signal, and an output terminal (e.g., the source 270) may be electrically connected to the pixel electrode 410. The active layer 230 may include a silicon-based semiconductor material such as amorphous silicon, polycrystalline silicon, or monocrystalline silicon, or may include an oxide semiconductor material or the like. The active layer 230 may serve as a channel of the switching element 200 and the channel may be turned on or off according to a voltage applied to the gate 210.

An interlayer 310 may be disposed on the switching elements 200. The interlayer 310 may be disposed without distinction of the pixels PX1 and PX2 to insulate an upper component and a lower component from each other, and/or may minimize a step caused by the switching elements 200 arranged on the lower base substrate 110, electrodes, or lines including the gate line GL and the data line DL. The interlayer 310 may include one or more layers. For example, the interlayer 310 may include an organic layer made of an organic material, an inorganic layer made of an inorganic material, or a stacked structure of an organic layer and an inorganic layer.

A plurality of pixel electrodes 410 may be disposed on the interlayer 310. The pixel electrode 410 may be an electric field generating electrode which generates an electric field in the liquid crystal layer 31 along with a common electrode 430 which will be described below. The pixel electrodes 410 arranged for each of the pixels PX1 and PX2 may be independently controlled and different driving signals may be provided thereto. For example, the pixel electrode 410 may be electrically connected to the output terminal (e.g., the source 270) of the switching element 200 through a contact hole formed in the interlayer 310. An electric field formed by the pixel electrode 410 and the common electrode 430 may control the behavior of liquid crystals 33 located in corresponding pixels and rearrange the liquid crystals 33. The pixel electrode 410 may be made of a transparent conductive material. The transparent conductive material may include indium tin oxide (ITO), indium zinc oxide (IZO), zinc oxide (ZnO), indium(III) oxide (In₂O₃), indium gallium oxide (IGO) or aluminum zinc oxide (AZO), or the like. Although not illustrated in the drawing, the pixel electrode 410 may have a domain dividing part such as a fine slit or the like when viewed from above.

The lower liquid crystal alignment layer 501 may be disposed on the pixel electrodes 410. The lower liquid crystal alignment layer 501 may induce initial alignment of adjacent liquid crystals 33 in the liquid crystal layer 31. In this specification, the initial alignment of liquid crystals refers to an arrangement of liquid crystals in a state in which an electric field is not formed in a liquid crystal layer. In an exemplary embodiment, the lower liquid crystal alignment layer 501 may include a polyimide-based polymer. The lower liquid crystal alignment layer 501 and an upper liquid crystal alignment layer 601 will be described below in detail.

In some exemplary embodiments, the lower polarizing element may be disposed between the liquid crystal layer 31 and the backlight unit BLU. For example, the lower polarizing element may be disposed between the lower base substrate 110 and the backlight unit BLU or between the lower base substrate 110 and the liquid crystal layer 31. The lower polarizing element may function as an optical shutter along with the liquid crystal layer 31 and the upper polarizing element 930.

Next, the liquid crystal layer 31 will be described. The liquid crystal layer 31 includes the plurality of liquid crystals 33 which are initially aligned. In this specification, the “liquid crystal” refers to a uni-molecule having a liquid crystal property or an assembly of the uni-molecules. In an exemplary embodiment, the liquid crystals 33 may have negative dielectric anisotropy and a long axis of the liquid crystals 33 may be substantially aligned to be perpendicular to a plane in the initial alignment state. In some exemplary embodiments, the liquid crystals 33 may have a predetermined pretilt in the initial alignment state. In this case, an angle of the long axis of the liquid crystals 33 with respect to the plane to which the first direction X and the second direction Y belong may be about 80 degrees or more or about 85 degrees or more. The initial alignment of the liquid crystals 33 may be induced by the lower liquid crystal alignment layer 501 and the upper liquid crystal alignment layer 601 which will be described below.

When an electric field is formed between the pixel electrode 410 and the common electrode 430, the liquid crystals 33 may be inclined in a specific direction and may change a polarization state of light transmitted through the liquid crystal layer 31 in a vertical direction (see FIG. 2).

Next, the upper substrate 21 will be described. The upper substrate 21 may include an upper base substrate 130, a color conversion pattern 810, and the common electrode 430, and may further include the upper liquid crystal alignment layer 601.

The upper base substrate 130 may be a transparent substrate or a transparent film. For example, the upper base substrate 130 may be made of a glass material, quartz material, or translucent plastic material similar to the lower base substrate 110. In some exemplary embodiments, the upper base substrate 130 may be flexible and the LCD 1 may be a curved display device.

Light shielding members 710 may be disposed on one surface of the upper base substrate 130 (a lower surface of the upper base substrate 130 in FIG. 2). The light shielding member 710 may block transmission of light. For example, the light shielding member 710 may be made of a black pigment, a light-shielding colorant such as a black dye, or a non-translucent metal material. The light shielding member 710 may be disposed on a boundary between adjacent pixels when viewed from above to prevent color mixture defects between the adjacent pixels. For example, the light shielding member 710 may have a lattice shape (or substantially a lattice) having openings corresponding to the respective pixels PX1 and PX2 when viewed from above.

In some exemplary embodiments, a first wavelength band filter 730 may be disposed on the light shielding member 710. The first wavelength band filter 730 may be a wavelength-selective optical filter which transmits light in a specific wavelength band, blocks transmission of light in another specific wavelength band, and selectively transmits only light in some wavelength bands. The first wavelength band filter 730 may overlap the color conversion pattern 810 which will be described below. In an exemplary embodiment, the first wavelength band filter 730 may block transmission of light in a blue wavelength band and may transmit light having a longer peak wavelength than blue light, for example, light in a green wavelength band and/or red wavelength band, among light provided by the backlight unit BLU. For example, the first wavelength band filter 730 may be a color filter which selectively absorbs light in the blue wavelength band. The color filter may include a base resin and a colorant such as pigment or dye dissolved or dispersed in the base resin. In another exemplary embodiment, the first wavelength band filter 730 may be a distributed Bragg reflector which selectively reflects light in the blue wavelength band.

The first wavelength band filter 730 may be disposed in the second pixel PX2 and may not be disposed in the first pixel PX1. The first wavelength band filter 730 may block transmission of blue light which has not been color-converted by the color conversion pattern 810 and is transmitted, among blue light which is provided from the backlight unit BLU and incident on the color conversion pattern 810. Accordingly, a spectrum of green light displayed by the second pixel PX2 may be made sharper, color purity of the green light emitted through the second pixel PX2 may be improved so that display quality of the LCD 1 may be improved.

The color conversion pattern 810 may be disposed on the first wavelength band filter 730. The color conversion pattern 810 may convert a color of the transmitted light into a different color from the incident light. That is, the light transmitted through the color conversion pattern 810 may be converted into light in a predetermined specific wavelength band.

In an exemplary embodiment, the color conversion pattern 810 may include a material which converts or shifts a peak wavelength of the incident light into another specific peak wavelength, that is, a wavelength shift material 810q. The wavelength shift material 810q may include a quantum dot, a quantum rod, or a phosphor material. For example, the quantum dot may emit a specific color while electrons transition from a conduction band to a valence band. A material of the quantum dot may have a core-shell structure. The core may be a semiconductor nanocrystalline material. The core of the quantum dot may include silicon (Si)-based nanocrystals, II-VI group-based compound nanocrystals, and III-V group-based compound nanocrystals, but the present disclosure is not limited thereto. As a non-limiting example, the wavelength shift material 810q may include a core made of any one of cadmium selenide (CdSe), cadmium telluride (CdTe), cadmium sulfide (CdS), or indium phosphide (InP), and an external shell made of zinc sulfide (ZnS).

In an exemplary embodiment, the color conversion pattern 810 may be disposed in the second pixel PX2, and the wavelength shift material 810q of the color conversion pattern 810 may absorb at least some of the light provided from the backlight unit BLU to emit light having a peak wavelength of green. Accordingly, the color conversion pattern 810 may convert incident light into green light, and the second pixel PX2 may display green. The green light emitted by the wavelength shift material 810q may be emitted in various directions regardless of an incident angle and may contribute to improvement of side visibility of green expressed by the LCD 1.

Although not illustrated in the drawing, a red conversion pattern including a wavelength shift material which absorbs at least some of the light provided from the backlight unit BLU to emit light having a peak wavelength of red may be disposed in the third pixel of the LCD 1, for example, in a red pixel.

In another exemplary embodiment, the color conversion pattern 810 may be a color filter which transmits light in a specific wavelength band and absorbs light in another specific wavelength band. For example, the color conversion pattern 810 may be a color filter which selectively transmits only light in a green wavelength band by including a colorant which selectively absorbs light in a blue wavelength band and/or red wavelength band.

In some exemplary embodiments, a light-emitting pattern 850 may be disposed in the first pixel PX1. The light-emitting pattern 850 may transmit a color of the transmitted light without substantially converting the color. The light transmitted through the light-emitting pattern 850 may maintain the color of the light provided by the backlight unit BLU, that is, blue. Accordingly, the first pixel PX1 may display blue. A light transmittance of the light-emitting pattern 850 may be about 90% or more, about 92% or more, or 95% or more.

The light-emitting pattern 850 may include a base resin and scatterers 850p dispersed in the base resin. A material of the base resin is not particularly limited as long as it is a material having a high light transmittance and an excellent dispersion characteristic with respect to the scatterers 850p. For example, the base resin may be made of an organic material such as an epoxy resin, an acrylic resin, a cardo resin, an imide resin, or the like. The scatterers 850p may have a different refractive index from the base resin and may form an optical interface with the base resin. A material of the scatterers 850p is not particularly limited as long as it is a material which can scatter at least some transmitted light. For example, the material of the scatterers 850p may be metal oxide particles or organic particles. The metal oxide particles may include titanium oxide (TiO₂), zirconium oxide (ZrO₂), aluminum oxide (Al₂O₃), indium oxide (In₂O₃), zinc oxide (ZnO), tin oxide (SnO₂), or the like, and the organic particles may include an acrylic resin, a urethane-based resin, or the like. The light-emitting pattern 850 including the scatterers 850p may scatter and emit light in various directions regardless of an incident angle without converting a wavelength of blue light which is provided from the backlight unit BLU and transmitted through the light-emitting pattern 850. Accordingly, the light-emitting pattern 850 may contribute to improvement of side visibility of blue expressed by the LCD 1. In another exemplary embodiment, the light-emitting pattern 850 may be omitted.

In some exemplary embodiments, the color conversion pattern 810 and the light-emitting pattern 850 may be spaced apart from each other on any one of the light shielding members 710. That is, a side surface of the color conversion pattern 810 and a side surface of the light-emitting pattern 850 may be spaced apart from each other. For example, the color conversion pattern 810 and the light-emitting pattern 850 may be physically spaced apart from each other, and thus light emitted by the wavelength shift material 810q in the color conversion pattern 810 may be prevented from traveling toward the light-emitting pattern 850 and displaying green in the first pixel PX1, or blue light scattered by the scatterers 850p in the light-emitting pattern 850 may be prevented from traveling toward the color conversion pattern 810 and being color-converted.

A second wavelength band filter 750 may be disposed on the color conversion pattern 810 and the light-emitting pattern 850. The second wavelength band filter 750 is a wavelength-selective optical filter which transmits light in a specific wavelength band, reflects light in another specific wavelength band, and transmits only light in some wavelength bands. The second wavelength band filter 750 may be disposed over the first pixel PX1 and the second pixel PX2.

In an exemplary embodiment, the second wavelength band filter 750 may transmit light in a blue wavelength band, and reflect light having a longer peak wavelength than blue, for example, light in a green wavelength band and/or red wavelength band. For example, the second wavelength band filter 750 may be a distributed Bragg reflector which selectively transmits light in the blue wavelength band. The distributed Bragg reflector may include a plurality of stacked layers. As a non-limiting example, the distributed Bragg reflector may include low-refraction layers and high-refraction layers which are alternately stacked. A transmission wavelength band and a reflection wavelength band of the second wavelength band filter 750 may be controlled by a refractive index difference and a thickness difference of the low-refraction layer and the high-refraction layer, and/or the number of repeating units formed by the low-refraction layer and the high-refraction layer or the like.

The second wavelength band filter 750 may reflect the light emitted to the second wavelength band filter 750 (a lower side in FIG. 2) toward the upper base substrate 130 (an upper side in FIG. 2), that is, toward a viewer, among green light emitted by the wavelength shift material 810q in the second pixel PX2 displaying green in various directions and/or red light emitted by a wavelength shift material in the third pixel displaying red in various directions, and contribute to color display. Accordingly, use efficiency of light may be increased and display quality, such as brightness and color purity, of the LCD 1 may be improved. Also, a spectrum of blue light which is provided from the backlight unit BLU and incident on the color conversion pattern 810 and the light-emitting pattern 850 may be made sharper, and color purity of the blue light incident on the color conversion pattern 810 and the light-emitting pattern 850 may be improved.

An overcoating layer 330 may be disposed on the second wavelength band filter 750. The overcoating layer 330 may minimize a step caused by the light shielding member 710 disposed on the upper base substrate 130, and a component such as the color conversion pattern 810 or the light-emitting pattern 850. A material of the overcoating layer 330 is not particularly limited as long as it is a material having an excellent planarization characteristic and a high light transmittance. For example, the overcoating layer 330 may include an organic material such as an epoxy resin, an acrylic resin, an imide resin, a cardo resin, a siloxane resin, a silsesquioxane resin, or the like.

In some exemplary embodiments, a protective layer 910 may be disposed on the overcoating layer 330. The protective layer 910 may include a non-metal inorganic material. The inorganic material forming the protective layer 910 may include silicon oxide, silicon nitride, silicon oxynitride or silicon nitride oxide, or the like. The protective layer 910 may protect the overcoating layer 330 from being damaged in a process of forming the polarizing element 930 which will be described below. The present disclosure is not limited thereto, and when a linear pattern 930a of the polarizing element 930 is formed by a dry etching process, the protective layer 910 may serve as an etch stopper to prevent the overcoating layer 330 from being unintendedly etched. Also, adhesion of the linear pattern 930a with respect to the overcoating layer 330 made of an organic material may be improved, and damage or corrosion to the linear pattern 930a due to infiltration of air or moisture may be prevented so that reliability of the LCD 1 may be improved. In another exemplary embodiment, the protective layer 910 may be omitted. In this case, the linear pattern 930a of the polarizing element 930 may be directly disposed on the overcoating layer 330.

The polarizing element 930 may be disposed on the protective layer 910. The polarizing element 930 may be an upper polarizing element which functions as an optical shutter along with the liquid crystal layer 31 and the lower polarizing element. In an exemplary embodiment, the polarizing element 930 may be a reflective polarizing element including a plurality of linear patterns 930a forming a wire grid pattern. The reflective polarizing element may impart a polarization state to the transmitted light by transmitting a polarizing component oscillating in a direction parallel to a transmission axis of the reflective polarizing element and by partially reflecting a polarizing component oscillating in a direction crossing the transmission axis, for example, in a direction parallel to an reflection axis thereof. The plurality of linear patterns 930a may extend parallel to each other and spaced apart from each other. The transmission axis of the polarizing element 930 may be a direction substantially perpendicular to an extending direction of the linear pattern 930a, and the reflection axis may be a direction substantially parallel to the extending direction of the linear pattern 930a.

The linear pattern 930a of the polarizing element 930 may be made of a reflective metal material. The reflective metal material may include aluminum (Al), silver (Ag), gold (Au), copper (Cu), titanium (Ti), molybdenum (Mo), nickel (Ni) or an alloy thereof. In some exemplary embodiments, the linear pattern 930a may have a stacked structure of different metal patterns.

A capping layer 950 may be disposed on the polarizing element 930. The capping layer 950 may be disposed on the linear pattern 930a to cover and protect the linear pattern 930a, and may insulate the common electrode 430 to be described below and the linear pattern 930a from each other. The capping layer 950 may prevent damage or corrosion of the linear pattern 930a due to penetration of air or moisture and thus improve reliability of the LCD 1. Also, the capping layer 950 may planarize the polarizing element 930 including the plurality of linear patterns 930a, and define a void V between adjacent linear patterns 930a. A material of the capping layer 950 is not particularly limited, but the capping layer 950 may include an inorganic material such as silicon nitride or silicon oxide and/or an organic material such as an epoxy resin, an acrylic resin, an imide resin, a cardo resin, a siloxane resin, or a silsesquioxane resin.

The common electrode 430 may be disposed on the capping layer 950. The common electrode 430 may be disposed over the first pixel PX1 and the second pixel PX2 without distinction of the pixels PX1 and PX2 and a common voltage may be applied thereto. The common electrode 430 may form an electric field along with the pixel electrode 410. The common electrode 430 may be made of a transparent conductive material similar to the pixel electrode 410.

The upper liquid crystal alignment layer 601 may be disposed on the common electrode 430. The upper liquid crystal alignment layer 601 may induce initial alignment of adjacent liquid crystals 33 in the liquid crystal layer 31. The upper liquid crystal alignment layer 601 may include a polyimide-based polymer similar to the lower liquid crystal alignment layer 501.

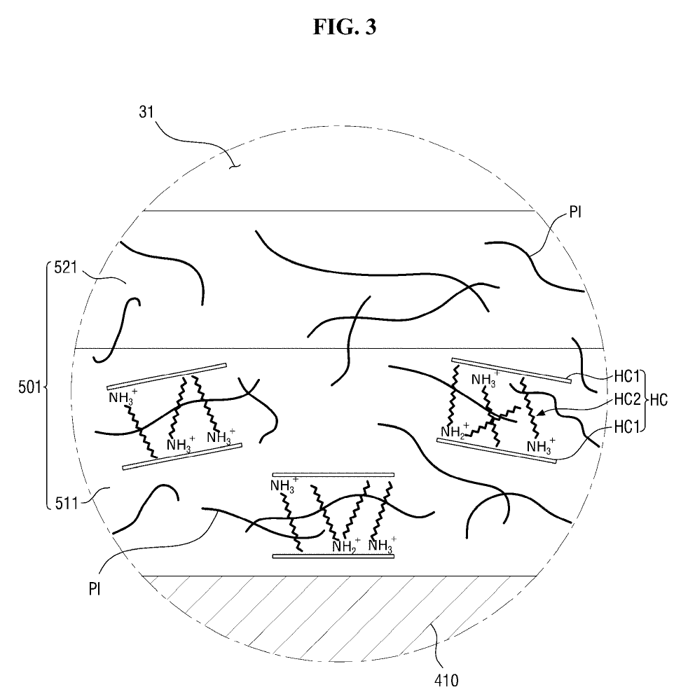

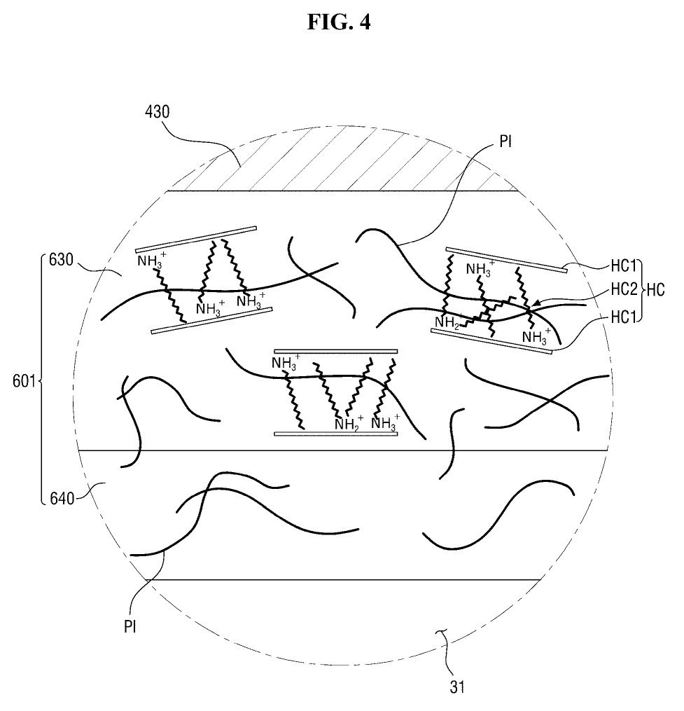

Hereinafter, the lower liquid crystal alignment layer 501 and the upper liquid crystal alignment layer 601 will be described in detail with further reference to FIGS. 3 and 4. FIG. 3 is an enlarged schematic view of area A of FIG. 2. FIG. 4 is an enlarged schematic view of area B of FIG. 2.

Referring to FIGS. 1 to 4, each of the lower liquid crystal alignment layer 501 and the upper liquid crystal alignment layer 601 may include a polyimide-based polymer PI, and may further include an organic-inorganic composite HC. In FIG. 2 or the like, the case in which both the lower liquid crystal alignment layer 501 and the upper liquid crystal alignment layer 601 include the organic-inorganic composite HC is illustrated. However, in another exemplary embodiment, any one of the lower liquid crystal alignment layer 501 and the upper liquid crystal alignment layer 601 may not include the organic-inorganic composite, or a content of the organic-inorganic composite HC in the lower liquid crystal alignment layer 501 may be different from a content of the organic-inorganic composite HC in the upper liquid crystal alignment layer 601.

First, the lower liquid crystal alignment layer 501 may be a vertical alignment-inducing layer for inducing initial vertical alignment of adjacent liquid crystals 33 in the liquid crystal layer 31. The lower liquid crystal alignment layer 501 includes a base made of a polyimide-based polymer PI and organic-inorganic composite HC dispersed in the base. In this specification, the organic-inorganic composite refers to a composite made of both an organic material and an inorganic material, or a hybrid composite having both characteristics of the organic material and the inorganic material.

In an exemplary embodiment, the lower liquid crystal alignment layer 501 may include a first layer 511 in contact with the pixel electrode 410 and a second layer 521 in contact with the liquid crystal layer 31. In FIG. 3, the case in which there is a physical boundary between the first layer 511 and the second layer 521 is illustrated, but the present disclosure is not limited thereto. In another exemplary embodiment, there may be no boundary that is at least partially physically visible between the first layer 511 and the second layer 521. That is, the first layer 511 may refer to a lower portion (toward the pixel electrode 410) of the lower liquid crystal alignment layer 501 in which the lower liquid crystal alignment layer 501 is formed by phase separation, and the second layer 521 may refer to an upper portion of the lower liquid crystal alignment layer 501 in which the lower liquid crystal alignment layer 501 is formed by phase separation. In still another exemplary embodiment, the lower liquid crystal alignment layer 501 may further include another layer interposed between the first layer 511 and the second layer 521.

Both the first layer 511 and the second layer 521 of the lower liquid crystal alignment layer 501 may include a polyimide-based polymer PI. The polyimide-based polymer PI may form a base of the first layer 511 and the second layer 521 of the lower liquid crystal alignment layer 501. At least a part of a chain-shaped polyimide-based polymer PI may be located over the first layer 511 and the second layer 521.

The polyimide-based polymer PI may be a polymer having an acid imide structure. For example, the polyimide-based polymer PI may be a condensation polymer of acid anhydride such as tetracarboxylic acid anhydride and diamine such as aromatic diamine. In an exemplary embodiment, the polyimide-based polymer PI may be a chain-shaped polymer including a main chain having an imide group in a repeating unit and a vertically aligned side chain bonded to the main chain, that is, a vertical alignment group.

In a non-limiting example, the polyimide-based polymer PI may be represented by the following Chemical Formula 1.

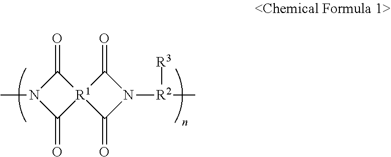

In Chemical Formula 1, R¹ may be a tetravalent group derived from alicyclic dianhydride or aromatic dianhydride. For example, the R¹ may be a tetravalent organic group having a carbon number of 4 to 12 and having an alicyclic ring. More particularly, for example, the R¹ may be selected from among

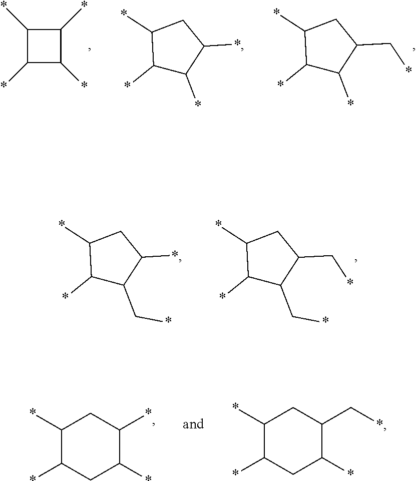

but the present disclosure is not limited thereto. Each carbon in the illustrated R¹ may be substituted by a halogen or an alkyl group.

R² may be a trivalent group derived from alicyclic diamine or aromatic diamine. For example, the R² may be a trivalent organic group having a carbon number of 5 to 12 and having an aliphatic ring or an aromatic ring. More particularly, for example, the R² may be selected from among

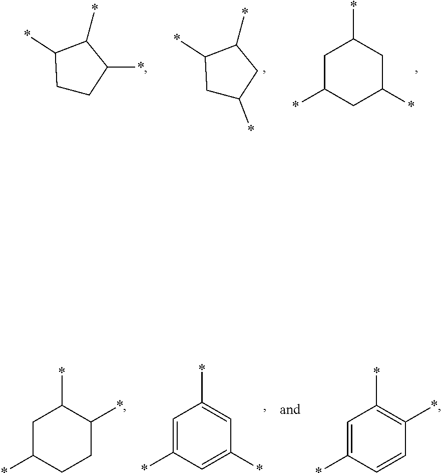

but the present disclosure is not limited thereto. Each carbon in the illustrated R² may be substituted by a halogen or an alkyl group.

R³ may be a vertically aligned side chain bonded to the R² or hydrogen. When the R³ is hydrogen, it means that there is no bonded side chain in the corresponding repeating unit of the main chain. When the R³ is a vertically aligned side chain, the R³ is not particularly limited as long as it has a sufficient length and is an aliphatic or aromatic hydrocarbon group having a lyophilic property. For example, the R³ may be selected from the followings.

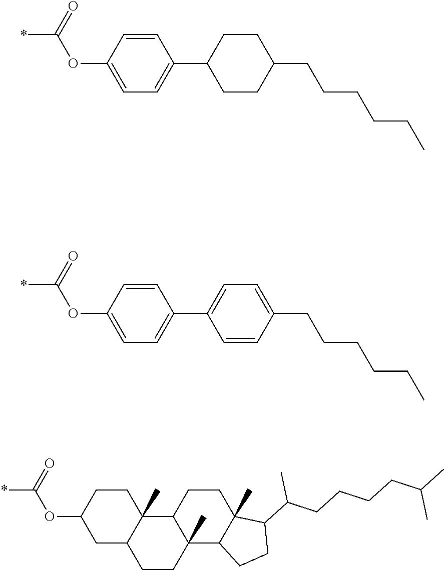

The vertically aligned side chain of the polyimide-based polymer PI, that is, the vertical alignment group, may have affinity with the liquid crystals 33 to induce initial vertical alignment of liquid crystals 33 adjacent to the lower liquid crystal alignment layer 501. A vertical alignment group of the polyimide-based polymer PI of the first layer 511 of the lower liquid crystal alignment layer 501 as well as the vertical alignment group of the polyimide-based polymer PI of the second layer 521 of the lower liquid crystal alignment layer 501 may at least partially contribute to the vertical alignment of the liquid crystals 33. As a non-limiting example, a degree of contribution of the second layer 521 of the lower liquid crystal alignment layer 501 to the initial alignment of the liquid crystals 33 may be greater than a degree of contribution of the first layer 511 of the lower liquid crystal alignment layer 501 to the initial alignment of the liquid crystals 33.

In some exemplary embodiments, the polyimide-based polymer PI may further include an ion-trapping side chain bonded to the main chain having an imide group in the repeating unit, that is, an ion trapper.

The number of the repeating units of the main chain of the polyimide-based polymer PI may be defined by n. In a non-limiting example, n may be an integer of 10 to 4,000. The R¹'s, R²'s, and R³'s in the repeating units of the polyimide-based polymer PI may be the same or different from each other.

The first layer 511 of the lower liquid crystal alignment layer 501 may include organic-inorganic composite HC. The organic-inorganic composite HC may be substantially uniformly dispersed and disposed in the first layer 511 of the lower liquid crystal alignment layer 501. In FIG. 3, the case in which the organic-inorganic composite HC are dispersed and disposed in the first layer 511 and are not disposed in the second layer 521, that is, a content of the organic-inorganic composite HC in the second layer 521 is 0, is illustrated. In another exemplary embodiment, at least a part of the organic-inorganic composite HC may be dispersed and disposed in the second layer 521, and a content of the organic-inorganic composite HC in the first layer 511 may be greater than the content of the organic-inorganic composite HC in the second layer 521. In other words, the content, dispersion density, or concentration of the organic-inorganic composite HC in the lower liquid crystal alignment layer 501 according to the present exemplary embodiment may be partially non-uniform.

The organic-inorganic composite HC may include a layered inorganic substance HC1 having a layered structure and an ammonium compound HC2. The organic-inorganic composite HC may be an organic-inorganic composite particle including the layered inorganic substance HC1 and the ammonium compound HC2.

The layered inorganic substance HC1 having the layered structure may include layers densely disposed through relatively strong bond such as covalent bond or ionic bond, and have a structure in which a plurality of layers overlap in parallel by a relatively weak bonding force such as a van der Waals force or the like. A type of the layered inorganic substance HC1 is not particularly limited as long as the layered inorganic substance HC1 has a predetermined distance between the layers and has an interlayer structure in which an organic material may penetrate therebetween. The layered inorganic substance HC1 may include crystalline silicates having a layered structure, for example, kaolin-based inorganic substances, such as kaolinite, dicalite, and heliosite, montmorillonite-based inorganic substances, such as montmorillonite, bentonite, hectorite and saponite, or mixed inorganic substances, such as zeolite and ilite. A distance between the layers of the layered inorganic substance HC1 may range from about 15 Å to about 30 Å.

At least a part of the ammonium compound HC2 may be located between the layers of the layered inorganic substance HC1. That is, the ammonium compound HC2 may enter or penetrate between the layers of the layered inorganic substance HC1 to form an organic-inorganic composite interlayer compound along with the layered inorganic substance HC1. The ammonium compound HC2 may be a monovalent alkyl ammonium salt in the form of an ammonium salt. In a non-limiting example, the ammonium compound HC2 may be represented by the following Chemical Formula 2.

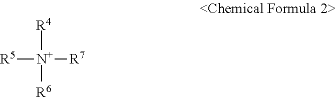

In the above Chemical Formula 2, each of R⁴ and R⁵ may be hydrogen or a methyl group (—CH₃). R⁶ may be hydrogen or a linear-chain or branched-chain alkyl group having a carbon number of 12 to 20. R⁷ may be a linear-chain or branched-chain alkyl group having a carbon number of 12 to 20. The R⁶ and R⁷ may be identical or different from each other.

The ammonium compound HC2 may include a hydrocarbon group (i.e., R⁶ or R⁷) having a predetermined length. The hydrocarbon group may be located between the layers of the layered inorganic substance HC1 to maintain a distance between adjacent layers, and may form a physical/chemical attractive force with the layers of the layered inorganic substance HC1. As will be described below, a structure entangled with the polyimide-based polymer PI located between the layers of the layered inorganic substance HC1 may be formed, and accordingly, the overall film hardness of the lower liquid crystal alignment layer 501 may be improved.

In some exemplary embodiments, the ammonium compound HC2 represented by the above Chemical Formula 2 may include an alkyl ammonium salt represented by the following Chemical Formula 2A and an alkyl ammonium salt represented by the following Chemical Formula 2B. A content of the alkyl ammonium salt represented by the Chemical Formula 2A may be greater than a content of the alkyl ammonium salt represented by the Chemical Formula 2B.

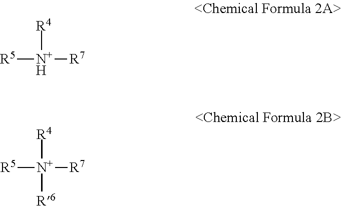

In the above Chemical Formula 2A and Chemical Formula 2B, R⁴, R⁵, and R⁷ are the same as those defined in the above Chemical Formula 2. R′⁶ is a linear-chain or branched-chain alkyl group having a carbon number of 12 to 20.

The content of the alkyl ammonium salt represented by the above Chemical Formula 2A may be greater than the content of the alkyl ammonium salt represented by the above Chemical Formula 2B so that the organic-inorganic composite HC may be stably formed in the form of particles. Further, aggregation between the ammonium compounds HC2 may be prevented.

In an exemplary embodiment, the ammonium compound HC2 represented by the above Chemical Formula 2 may include a tetradecyl ammonium salt in which R⁷ is a linear-chain or branched-chain tetradecyl group (—C₁₄H₂₉), a hexadecyl ammonium salt in which R⁷ is a linear-chain or branched-chain hexadecyl group (—C₁₆H₃₃), and an octadecyl ammonium salt in which R⁷ is a linear-chain or branched-chain octadecyl group (—C₁₈H₃₇).

In some exemplary embodiments, a content (i.e., weight) of the octadecyl ammonium salt may be greater than a content of the hexadecyl ammonium salt, and the content of the hexadecyl ammonium salt may be greater than a content of the tetradecyl ammonium salt. For example, the content (i.e., weight) of the octadecyl ammonium salt may be greater than a sum of the content of the tetradecyl ammonium salt and the content of the hexadecyl ammonium salt.

As a non-limiting example, a content of the octadecyl ammonium salt in the lower liquid crystal alignment layer 501 may be in a proportion of about 40.0% to 65.0% by weight of a total content of the organic-inorganic composite HC in the lower liquid crystal alignment layer 501, a content of the hexadecyl ammonium salt in the lower liquid crystal alignment layer 501 may be in a proportion of about 15.0% to 30.0% by weight of the total content of the organic-inorganic composite HC in the lower liquid crystal alignment layer 501, and a content of the tetradecyl ammonium salt in the lower liquid crystal alignment layer 501 may be in a proportion of about 1.0% to 5.0% by weight of the total content of the organic-inorganic composite HC in the lower liquid crystal alignment layer 501. The aggregation between the organic-inorganic composite HC may be prevented by including the tetradecyl ammonium salt and the hexadecyl ammonium salt having a carbon number of 16 or less to a sufficient extent, a distance between the layers of the layered inorganic substance HC1 may be maintained by including the octadecyl ammonium salt in a proportion of about 40.0% to 65.0%, that is, about half, and a physical/chemical attractive force with the polyimide-based polymer PI may be improved.

At least a part of the above-described polyimide-based polymer PI may be located between the layers of the layered inorganic substance HC1. That is, at least a part of the main chain of the polyimide-based polymer PI may enter or penetrate between the layers of the layered inorganic substance HC1. The main chain of the polyimide-based polymer PI may form a structure entangled with the hydrocarbon group (e.g., the alkyl group having a carbon number of 12 to 20) of the ammonium compound HC2, and may form a physical/chemical attractive force with the layers of the layered inorganic substance HC1 and/or the ammonium compound HC2. Accordingly, structural stability of the polyimide-based polymer PI in the lower liquid crystal alignment layer 501 may be improved and physical/chemical stability of the polyimide-based polymer PI forming the base of the first layer 511 of the lower liquid crystal alignment layer 501 may be improved so that film hardness of the first layer 511 may be improved. Furthermore, the overall film hardness of the lower liquid crystal alignment layer 501 contributing to initial alignment of adjacent liquid crystals 33 as well as the first layer 511 may be improved, and display quality defects, such as after-image defects, light leakage defects, or the like, caused while the LCD 1 is driven may be prevented.

Meanwhile, the upper liquid crystal alignment layer 601 may be a vertical alignment-inducing layer for inducing initial vertical alignment of adjacent liquid crystals 33 in the liquid crystal layer 31 similar to the lower liquid crystal alignment layer 501. The upper liquid crystal alignment layer 601 includes a base made of polyimide-based polymer PI and organic-inorganic composite HC dispersed in the base.

In an exemplary embodiment, the upper liquid crystal alignment layer 601 may include a third layer 630 in contact with the common electrode 430 and a fourth layer 640 in contact with the liquid crystal layer 31. In FIG. 4 or the like, the case in which there is a physical boundary between the third layer 630 and the fourth layer 640 is illustrated, but the present disclosure is not limited thereto. In another exemplary embodiment, there may be no boundary that is at least partially physically visible between the third layer 630 and the fourth layer 640. That is, the third layer 630 may refer to a lower portion (toward the common electrode 430) of the upper liquid crystal alignment layer 601 in which the upper liquid crystal alignment layer 601 is formed by phase separation, and the fourth layer 640 may refer to an upper portion of the upper liquid crystal alignment layer 601 in which the upper liquid crystal alignment layer 601 is formed by phase separation. In still another exemplary embodiment, the upper liquid crystal alignment layer 601 may further include another layer interposed between the third layer 630 and the fourth layer 640.

Both the third layer 630 and the fourth layer 640 of the upper liquid crystal alignment layer 601 may include a polyimide-based polymer PI. The polyimide-based polymer PI may form a base of the third layer 630 and the fourth layer 640 of the upper liquid crystal alignment layer 601. At least a part of a chain-shaped polyimide-based polymer PI may be located over the third layer 630 and the fourth layer 640.

The polyimide-based polymer PI may be a chain-shaped polymer including a main chain having an imide group in a repeating unit and a vertically aligned side chain bonded to the main chain, that is, a vertical alignment group. The vertical alignment group of the polyimide-based polymer PI may have affinity with the liquid crystals 33 to induce the initial vertical alignment of liquid crystals 33 adjacent to the upper liquid crystal alignment layer 601. The vertical alignment group of the polyimide-based polymer PI of the third layer 630 of the upper liquid crystal alignment layer 601 as well as the vertical alignment group of the polyimide-based polymer PI of the fourth layer 640 of the upper liquid crystal alignment layer 601 may at least partially contribute to the vertical alignment of the liquid crystals 33. As a non-limiting example, a degree of contribution of the fourth layer 640 of the upper liquid crystal alignment layer 601 to the initial alignment of the liquid crystals 33 may be greater than a degree of contribution of the third layer 630 of the upper liquid crystal alignment layer 601 to the initial alignment of the liquid crystals 33.

Further, the third layer 630 of the upper liquid crystal alignment layer 601 may include organic-inorganic composite HC. The organic-inorganic composite HC may be substantially uniformly dispersed and disposed in the third layer 630 of the upper liquid crystal alignment layer 601. In FIG. 4, the case in which the organic-inorganic composite HC are dispersed and disposed in the third layer 630 and are not disposed on the fourth layer 640 is illustrated. In another exemplary embodiment, at least a part of the organic-inorganic composite HC may be dispersed and disposed in the fourth layer 640, and a content of the organic-inorganic composite HC of the third layer 630 may be greater than a content of the organic-inorganic composite HC of the fourth layer 640. The content of the organic-inorganic composite HC in the upper liquid crystal alignment layer 601 according to the present exemplary embodiment may be partially non-uniform.

At least a part of the polyimide-based polymer PI may be located between the layers of the layered inorganic substance HC1. The main chain of the polyimide-based polymer PI may form a structure entangled with the hydrocarbon group (e.g., the alkyl group having a carbon number of 12 to 20) of the ammonium compound HC2, and may form a physical/chemical attractive force with the layers of the layered inorganic substance HC1 and/or the ammonium compound HC2. Accordingly, structural stability of the polyimide-based polymer PI in the upper liquid crystal alignment layer 601 may be improved and film hardness of the third layer 630 of the upper liquid crystal alignment layer 601 may be improved. Furthermore, the overall film hardness of the upper liquid crystal alignment layer 601 contributing to initial alignment of adjacent liquid crystals 33 as well as the third layer 630 may be improved.

Since the polyimide-based polymer PI, the organic-inorganic composite HC including the layered inorganic substance HC1 and the ammonium compound HC2, and a bonding relationship between the polyimide-based polymer PI and the organic-inorganic composite HC are the same as those in the lower liquid crystal alignment layer 501, repetitive descriptions thereof will be omitted.

Hereinafter, other exemplary embodiments will be described. However, a description of the same configuration as that of the LCD 1 according to the exemplary embodiment of FIG. 2 or the like described above will be omitted, and it will be apparent to those skilled in the art from the accompanying drawings.

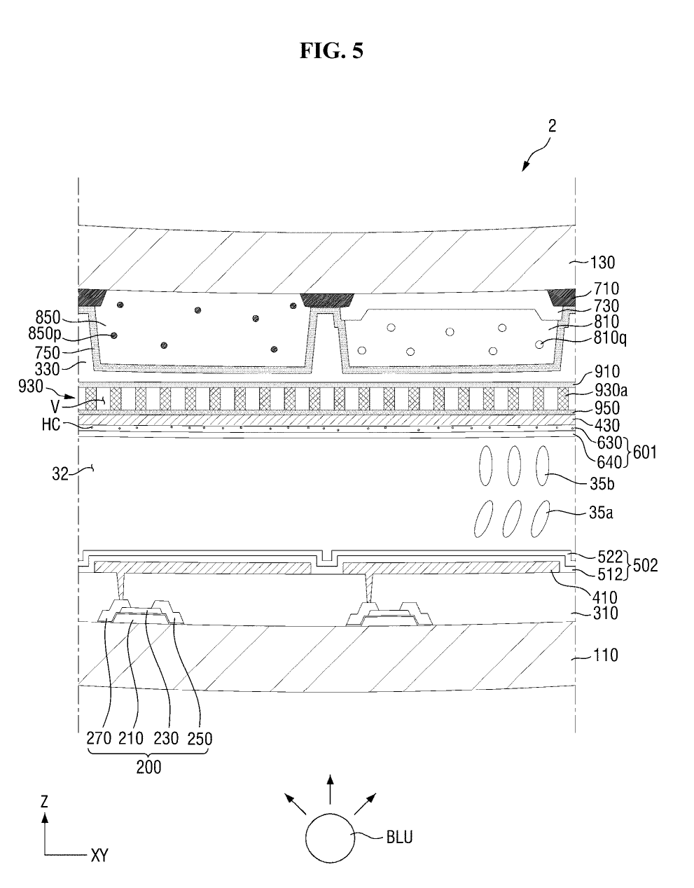

FIG. 5 is a cross-sectional view an LCD according to another exemplary embodiment.

Referring to FIG. 5, an LCD 2 according to the present exemplary embodiment differs from the LCD 1 according to the exemplary embodiment illustrated in FIG. 2 or the like in that a lower liquid crystal alignment layer 502 does not include an organic-inorganic composite HC.

In an exemplary embodiment, the LCD 2 may be a curved LCD. For example, a lower surface of the upper base substrate 130 facing the lower base substrate 110 and a lower surface of the lower base substrate 110 facing the backlight unit BLU may be convexly bent. In addition, an upper surface of the upper base substrate 130 facing a viewer and an upper surface of the lower base substrate 110 facing the upper base substrate 130 may be concavely bent. The components between the lower base substrate 110 and the upper base substrate 130 may also be appropriately bent.

A liquid crystal layer 32 may include a plurality of initially aligned liquid crystals 35a and 35b. The liquid crystals 35a and 35b may have negative dielectric anisotropy and long axes of the liquid crystals 35a and 35b may be substantially aligned to be perpendicular to a plane in the initial alignment state. For example, the liquid crystal layer 32 may include first liquid crystals 35a adjacent to the lower liquid crystal alignment layer 502 and a second liquid crystals 35b adjacent to the upper liquid crystal alignment layer 601. In an exemplary embodiment, a pretilt angle of the first liquid crystals 35a may be greater than a pretilt angle of the second liquid crystals 35b. In this specification, the pretilt angle refers to an angle formed by the long axis of the liquid crystal with a normal line of a plane to which a first direction X and a second direction Y belong. That is, a pretilt angle of the liquid crystal when the liquid crystal is completely vertically aligned without being pretilted is 0 degrees.

The pretilt angle of the first liquid crystals 35a located at a lower portion of the liquid crystal layer 32 may be greater than the pretilt angle of the second liquid crystals 35b located at an upper portion of the liquid crystal layer 32 so that display quality defects, such as texture and the like, which are generated in the curved LCD, may be prevented.

The lower liquid crystal alignment layer 502 and the upper liquid crystal alignment layer 601 may induce initial alignment of adjacent first liquid crystals 35a and adjacent second liquid crystals 35b in the liquid crystal layer 32, respectively. Each of the lower liquid crystal alignment layer 502 and the upper liquid crystal alignment layer 601 may include a polyimide-based polymer and the upper liquid crystal alignment layer 601 and may further include an organic-inorganic composite HC. In FIG. 5, the case in which the lower liquid crystal alignment layer 502 does not include the organic-inorganic composite HC, that is, a content of the organic-inorganic composite HC in the lower liquid crystal alignment layer 502 is 0 is illustrated. In another exemplary embodiment, a first layer 512 of the lower liquid crystal alignment layer 502 may include the organic-inorganic composite HC, and the content of the organic-inorganic composite HC in the lower liquid crystal alignment layer 502 may be smaller than a content of the organic-inorganic composite HC in the upper liquid crystal alignment layer 601.

First, the lower liquid crystal alignment layer 502 may be a vertical alignment-inducing layer for inducing initial vertical alignment of adjacent first liquid crystals 35a in the liquid crystal layer 32. The lower liquid crystal alignment layer 502 may include a polyimide-based polymer. In an exemplary embodiment, the lower liquid crystal alignment layer 502 may include the first layer 512 in contact with the pixel electrode 410 and a second layer 522 in contact with the liquid crystal layer 32. In FIG. 5, the case in which there is a physical boundary between the first layer 512 and the second layer 522 is illustrated. However, there may be no boundary that is at least partially physically visible between the first layer 512 and the second layer 522, or the first layer 512 and the second layer 522 may be formed without distinction of the first layer 512 and the second layer 522. Both the first layer 512 and the second layer 522 of the lower liquid crystal alignment layer 502 may include the polyimide-based polymer. Since the polyimide-based polymer have been described with reference with FIGS. 3 and 4, a repetitive description thereof will be omitted.

Meanwhile, the upper liquid crystal alignment layer 601 may be a vertical alignment-inducing layer for inducing initial vertical alignment of adjacent second liquid crystals 35b in the liquid crystal layer 32. The upper liquid crystal alignment layer 601 includes a base made of a polyimide-based polymer and an organic-inorganic composite HC dispersed in the base. Since the upper liquid crystal alignment layer 601 is the same as that described above with reference with FIG. 4 or the like, a repetitive description thereof will be omitted.

In an exemplary embodiment, the lower liquid crystal alignment layer 502 may not include the organic-inorganic composite HC, or the content of the organic-inorganic composite HC in the lower liquid crystal alignment layer 502 may be smaller than the content of the organic-inorganic composite HC in the upper liquid crystal alignment layer 601. Accordingly, pretilts of the first liquid crystals 35a and the second liquid crystals 35b may be differently formed.

The present disclosure is not limited thereto, but, for example, at least a part of the polyimide-based polymer in the third layer 630 of the upper liquid crystal alignment layer 601 may be located between the layers of the layered inorganic substance of the organic-inorganic composite HC. In this case, the polyimide-based polymer penetrating between the layers of the layered inorganic substance may not contribute to initial alignment of the liquid crystals. This is because a vertically aligned side chain of the polyimide-based polymer is covered by the layers of the layered inorganic substance of the organic-inorganic composite HC and does not form any physical/chemical interaction force with the second liquid crystals 35b.

A degree of contribution of the lower liquid crystal alignment layer 502 according to the present exemplary embodiment to the initial vertical alignment of the first liquid crystals 35a may be greater than a degree of contribution of the upper liquid crystal alignment layer 601 to the initial vertical alignment of the second liquid crystals 35b, and a pretilt angle of the first liquid crystals 35a may be made greater than a pretilt angle of the second liquid crystals 35b through polymerization of a reactive mesogen as the same as in a method of manufacturing an LCD as will be described below. Therefore, a difference between the pretilt angles of the first liquid crystals 35a and the second liquid crystals 35b may be generated by only a difference between the contents of the organic-inorganic composite HC without any difference between a process of forming the lower liquid crystal alignment layer 502 and a process of forming the upper liquid crystal alignment layer 601.

Hereinafter, a method of manufacturing an LCD according to one exemplary embodiment will be described.

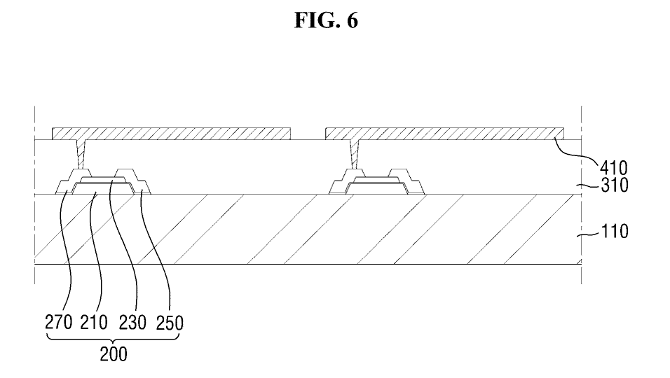

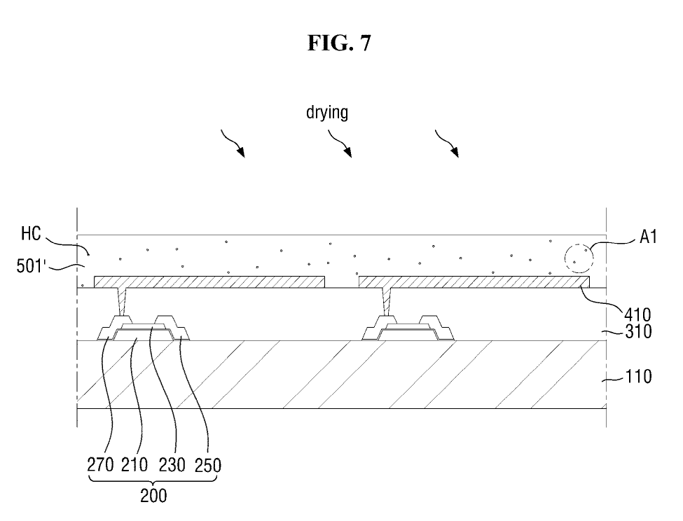

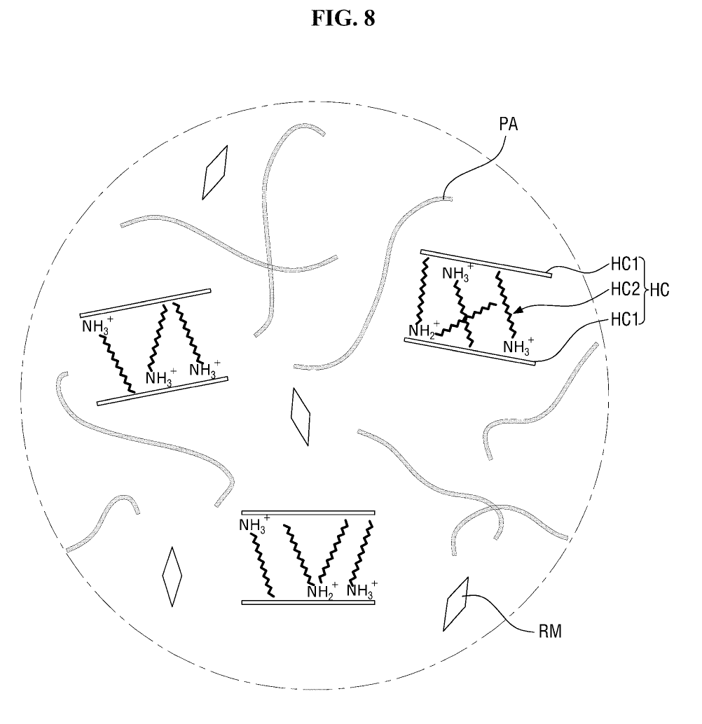

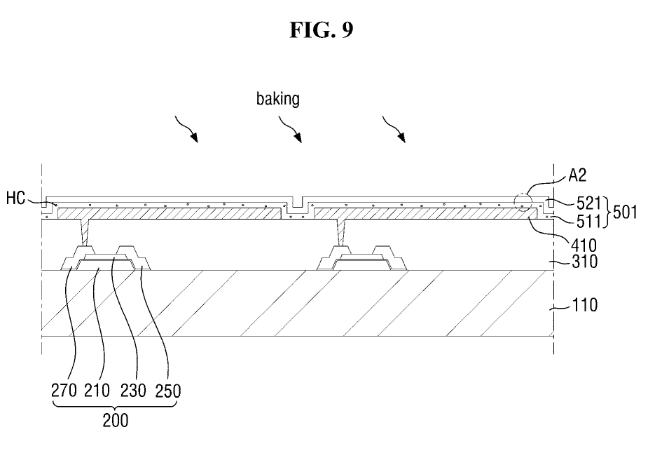

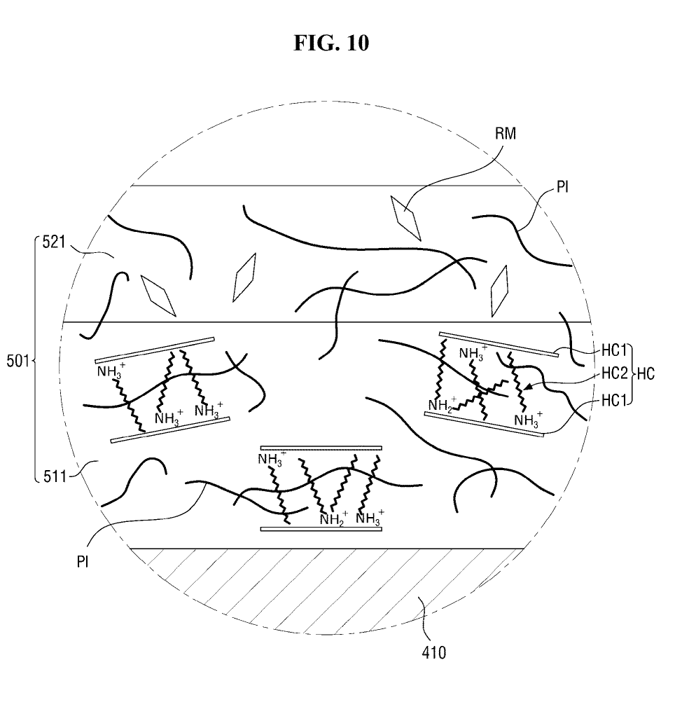

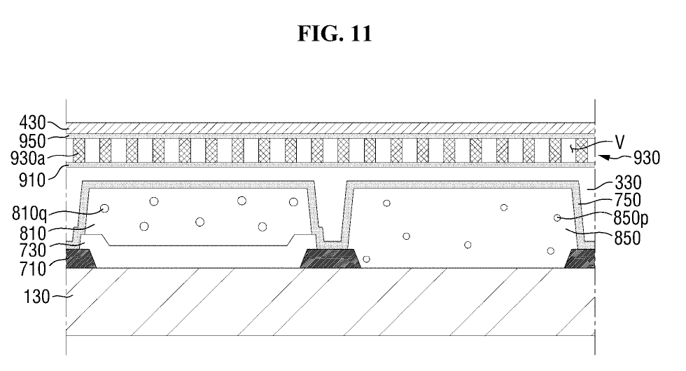

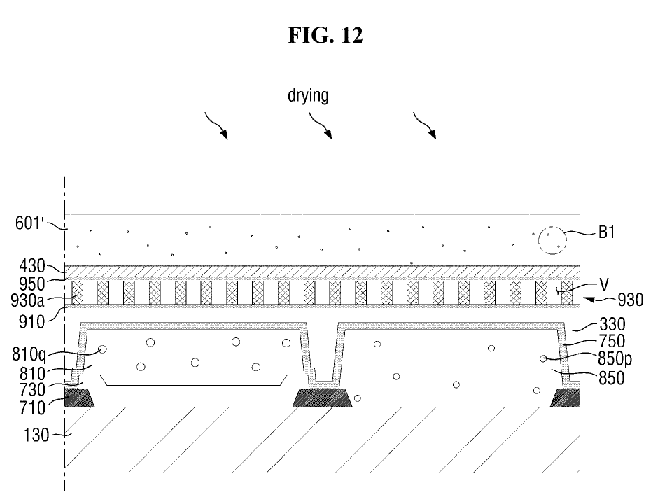

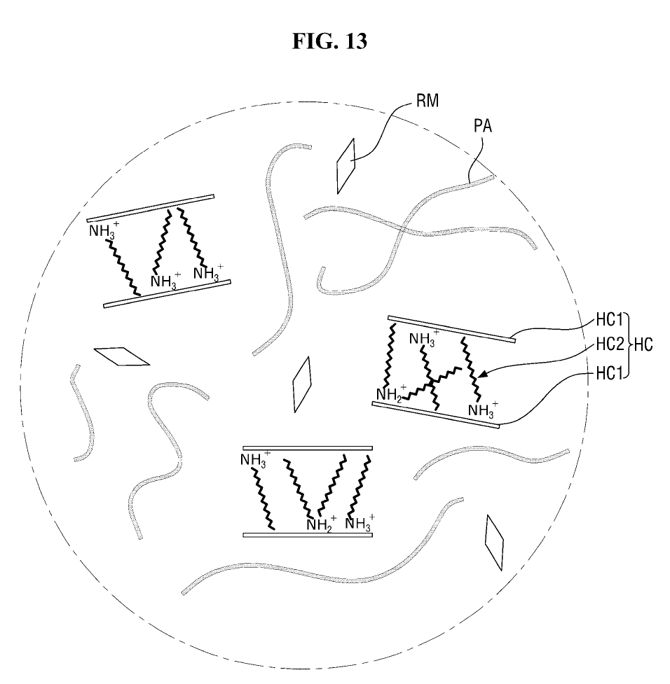

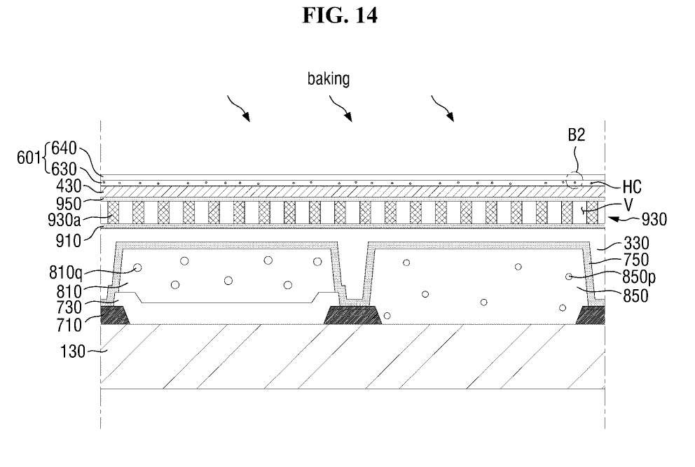

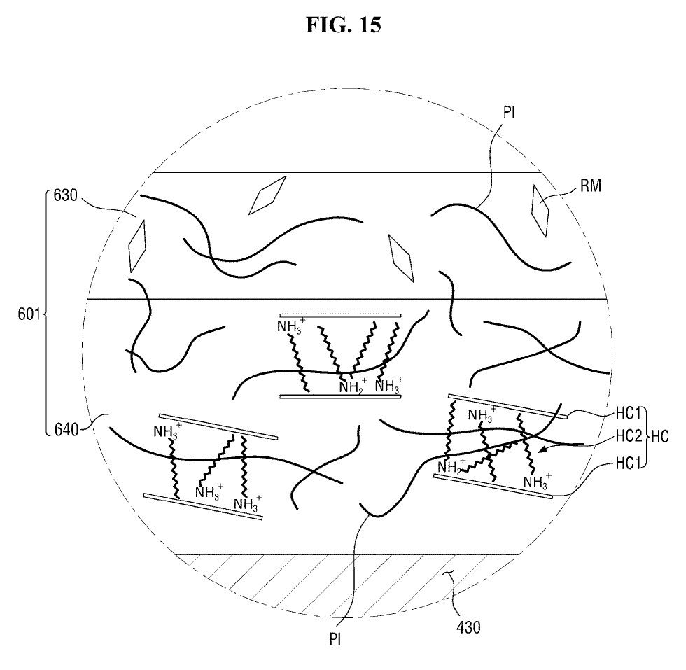

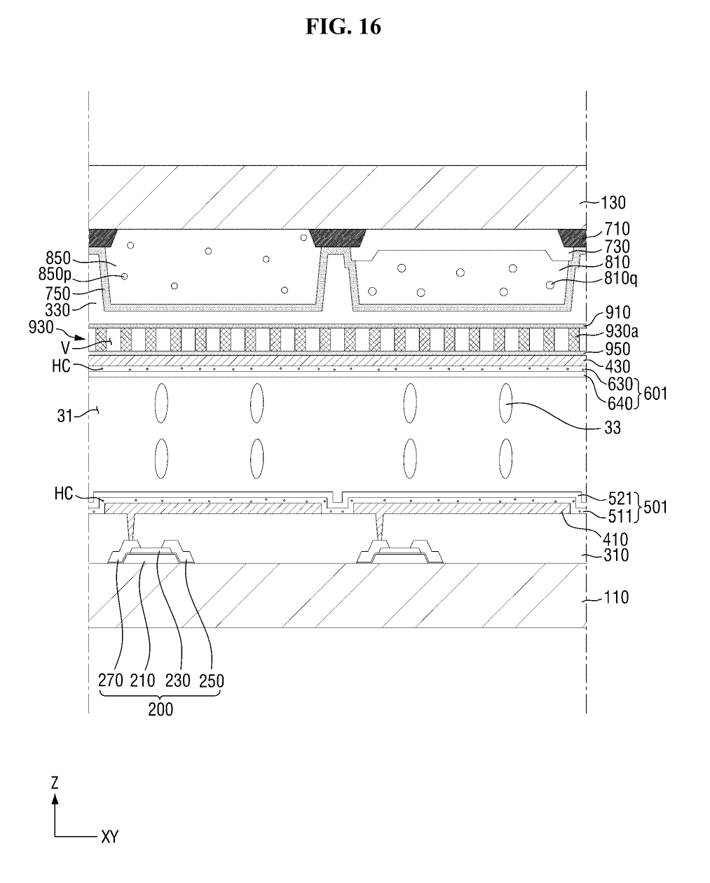

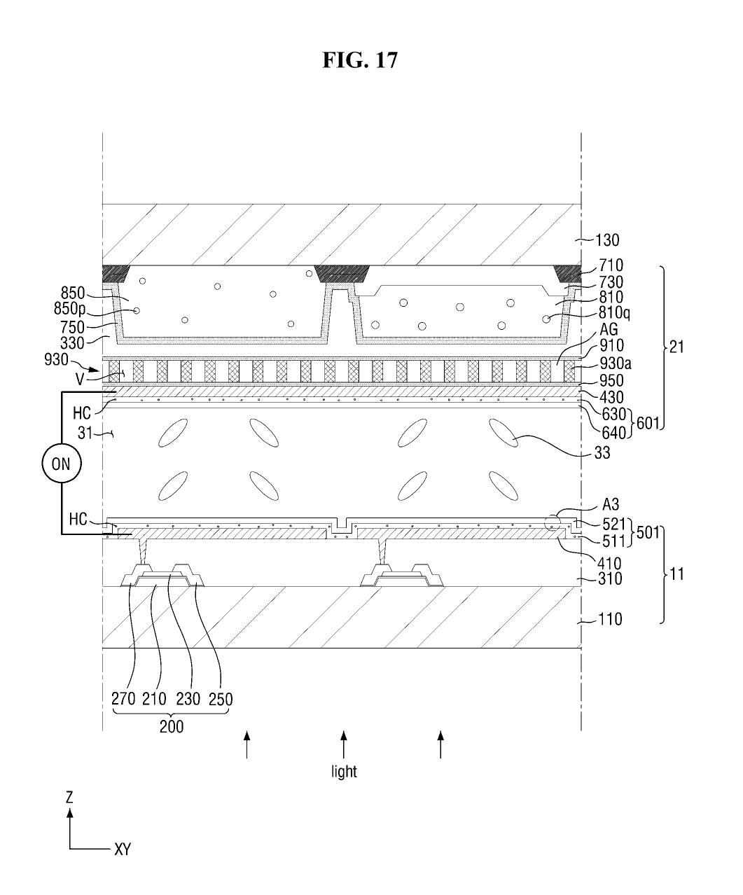

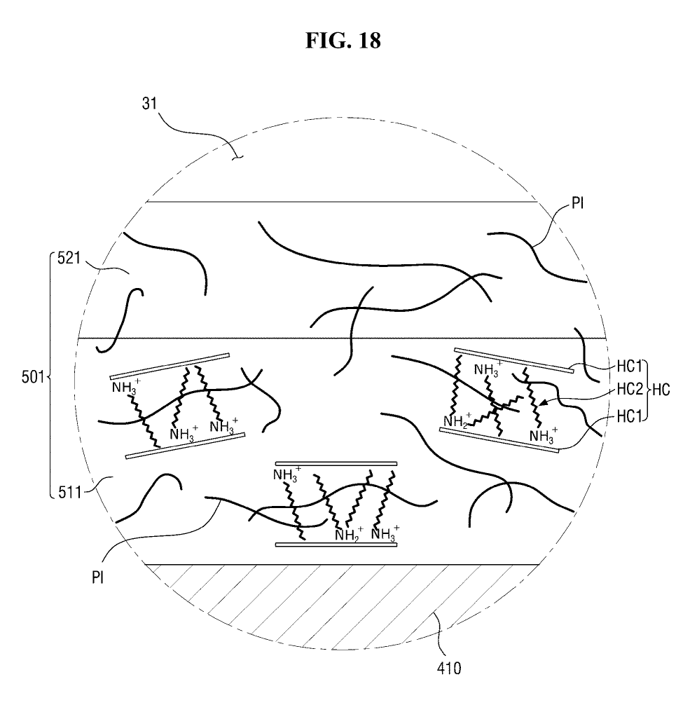

FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, and FIG. 19 are views illustrating the method of manufacturing an LCD according to one exemplary embodiment.

First, referring to FIG. 6, a lower base substrate 110, switching elements 200 disposed on the lower base substrate 110, an interlayer 310 disposed on the switching elements 200, and pixel electrodes 410 disposed on the interlayer 310 are prepared. Since the lower base substrate 110, the switching elements 200, the interlayer 310, and the pixel electrodes 410 have been described with reference to FIG. 2 or the like, repetitive descriptions thereof will be omitted.

Next, a lower liquid crystal alignment layer is formed on the pixel electrodes 410. In an exemplary embodiment, an operation of forming the lower liquid crystal alignment layer may include an operation of applying a liquid crystal alignment agent composition on the pixel electrodes 410, and an operation of baking the liquid crystal alignment agent composition and forming the lower liquid crystal alignment layer.

FIG. 7 is a view illustrating an operation of applying and drying the liquid crystal alignment agent composition on the pixel electrodes 410, and FIG. 8 is an enlarged schematic view of area A1 of FIG. 7. Specifically, referring to FIGS. 7 and 8, a liquid crystal alignment agent composition 501′ is applied on the pixel electrodes 410, and the liquid crystal alignment agent composition 501′ is dried.

The liquid crystal alignment agent composition 501′ may be a composition for forming a lower liquid crystal alignment layer. The liquid crystal alignment agent composition 501′ may include polyamic acid PA as a precursor of a polyimide-based polymer or may include polyimide, and may further include organic-inorganic composite HC and a solvent.

In a non-limiting example, the polyamic acid PA may be represented by the following Chemical Formula 3.

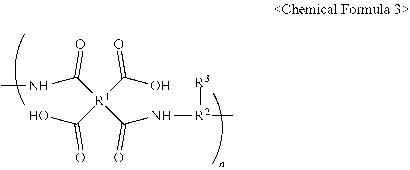

In the above Chemical Formula 3, R¹, R², R³, and n are respectively the same as those described in Chemical Formula 1.

The polyamic acid PA may be at least partially dissolved in a solvent or may be uniformly dispersed in the solvent. The organic-inorganic composite HC may be uniformly dispersed in the solvent. The solvent is not particularly limited as long as the solvent may partially dissolve the polyamic acid PA. For example, a polar solvent such as N-methyl-2-pyrrolidone or γ-butyrolactone may be used. In some exemplary embodiments, a content of the organic-inorganic composite HC may range from about 0.1 wt % to 2.0 wt % or about 0.1 wt % to 0.25 wt % with respect to a total weight of the liquid crystal alignment agent composition 501′. When the content of the organic-inorganic composite HC is 2.0 wt % or less, film hardness of the lower liquid crystal alignment layer may be improved, aggregation between the organic-inorganic composite HC may be prevented, and degradation of an initial alignment property of the liquid crystals of the lower liquid crystal alignment layer may be prevented.

The organic-inorganic composite HC may include a layered inorganic substance HC1 having a layered structure and an ammonium compound HC2. The ammonium compound HC2 may be an alkyl ammonium salt. At least a part of the ammonium compound HC2 may be located at between layers of the layered inorganic substance HC1. Since the organic-inorganic composite HC including the layered inorganic substance HC1 and the ammonium compound HC2 is the same as that described with reference to FIG. 4 or the like, a repetitive description thereof will be omitted.

In some exemplary embodiments, the liquid crystal alignment agent composition 501′ may further include a reactive mesogen RM. The reactive mesogen RM may include a core structure having a mesogenic skeleton and a polymerizable group bonded to at least one of ends of the core structure.

As a non-limiting example, the reactive mesogen RM may be represented by the following Chemical Formula 4.

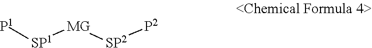

In the above Chemical Formula 4, MG may refer to a mesogen skeleton forming the core structure of the reactive mesogen RM. For example, the MG may be a divalent group having an aromatic ring and a carbon number of 6 to 24 and may have miscibility with the liquid crystals. More particularly, for example, the MG may be selected from the followings:

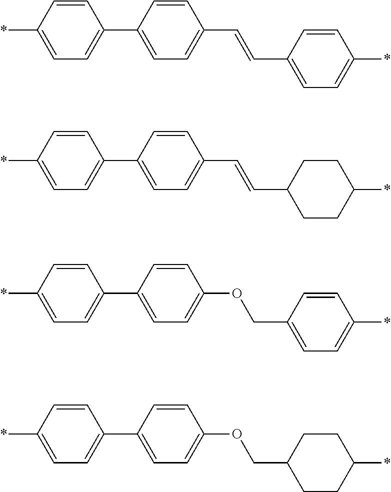 [SMILES: *c1ccc(/C=C/c2ccc(-c3ccc(*)cc3)cc2)cc1 ; *c1ccc(-c2ccc(/C=C/C3CCC(*)CC3)cc2)cc1 ; *c1ccc(COc2ccc(-c3ccc(*)cc3)cc2)cc1 ; *c1ccc(-c2ccc(OCC3CCC(*)CC3)cc2)cc1]

Further, each of SP¹ and SP² may refer to a spacer group connecting each core structure to an end group. The spacer group is not particularly limited as long as the spacer group is a hydrocarbon group having a predetermined length and flexibility, and, for example, each of the SP¹ and SP² may be any one of single bond, an alkylene group having a carbon number of 1 to 5, and an alkoxylene group having a carbon number of 1 to 5. However, the present disclosure is not limited thereto. The SP¹ and SP² may be identical or different from each other.

Each of P¹ and P² may refer to an end group of the reactive mesogen RM. At least one of the P¹ and P² may be a polymerizable group. For example, both the P¹ and P² may be a polymerizable group, or any one of the P¹ and P² may be hydrogen. An example of the polymerizable group may include a (meth)acryloyl group or a (meth)acrylate group, but the present disclosure is not limited thereto.

A method of applying the liquid crystal alignment agent composition 501′ is not particularly limited, and, for example, the method may include spin coating, slit coating, or the like. In the operation of applying the liquid crystal alignment agent composition 501′, the liquid crystal alignment agent composition 501′ may be in a uniform solution state without phase separation, but the present disclosure is not limited thereto.

The operation of drying the liquid crystal alignment agent composition 501′ may be an operation of removing the solvent of the applied liquid crystal alignment agent composition 501′. The drying operation may be performed at a room temperature or at a temperature of about 30° C. to 50° C.

FIG. 9 is a view illustrating the operation of baking the liquid crystal alignment agent composition, and FIG. 10 is an enlarged schematic view of area A2 of FIG. 9. Next, referring to FIGS. 9 and 10, the liquid crystal alignment agent composition is baked to form the lower liquid crystal alignment layer 501.

The operation of baking the liquid crystal alignment agent composition may be an operation of dehydrating and cyclizing at least a part of the above-mentioned polyamic acid and forming the polyimide-based polymer PI. In an exemplary embodiment, at least a part of the polyimide-based polymer PI formed by dehydrating and cyclizing the polyamic acid may be inserted between the layers of the layered inorganic substance HC1 of the organic-inorganic composite HC and stabilized. That is, at least a part of a main chain of the polyimide-based polymer PI formed by dehydrating and cyclizing the polyamic acid may enter or penetrate between the layers of the layered inorganic substance HC1, a structure entangled with a hydrocarbon group (e.g., an alkyl group having a carbon number of 12 to 20) of the ammonium compound HC2 may be formed, and a physical/chemical attractive force with the layers of the layered inorganic substance HC1 and/or the ammonium compound HC2 may be formed and stabilized.

The operation of baking the liquid crystal alignment agent composition may be performed at a temperature of about 160° C. to 180° C. for about 600 seconds to 3,000 seconds. When the baking temperature is 160° C. or more, heat energy enough to induce dehydration cyclization reaction of the polyamic acid may be provided, and the polyimide-based polymer PI may penetrate between the layered inorganic substances HC1 of the organic-inorganic composite HC. When the baking temperature is 180° C. or less, damage to other components formed before the lower liquid crystal alignment layer 501 may be prevented. In addition, when the baking temperature is more than 180° C., structural arrangement stability of the polyimide-based polymer PI which penetrates between the layered inorganic substances HC1 of the organic-inorganic composite HC may be lowered. Furthermore, when the baking temperature is more than 180° C., effective phase separation may not occur due to an instant fluidity increase of the organic-inorganic composite HC and the reactive mesogen RM.

Further, in the operation of baking the liquid crystal alignment agent composition, the liquid crystal alignment agent composition may be phase-separated, and the lower liquid crystal alignment layer 501 including a first layer 511 in contact with the pixel electrode 410 and a second layer 521 located above the first layer 511 may be formed. The first layer 511 of the lower liquid crystal alignment layer 501 may include organic-inorganic composite HC. The organic-inorganic composite HC may be substantially uniformly dispersed and disposed in the first layer 511 of the lower liquid crystal alignment layer 501. In FIG. 10, the case in which the organic-inorganic composite HC is not disposed in the second layer 521 is illustrated. In another exemplary embodiment, at least a part of the organic-inorganic composite HC may be dispersed and disposed in the second layer 521, and a content of the organic-inorganic composite HC of the first layer 511 may be greater than a content of the organic-inorganic composite HC of the second layer 521.

Since the lower liquid crystal alignment layer 501 including the polyimide-based polymer PI and the organic-inorganic composite HC including the layered inorganic substance HC1 and the ammonium compound HC2 is the same as that described with reference to FIG. 3, a repetitive description thereof will be omitted.

In some exemplary embodiments, in the operation of baking the liquid crystal alignment agent composition, the second layer 521 of the lower liquid crystal alignment layer 501 may be in a state including the reactive mesogen RM. In FIG. 10, the case in which the reactive mesogen RM is not disposed in the first layer 511 is illustrated. In another exemplary embodiment, at least a part of the reactive mesogen RM may be dispersed and disposed in the first layer 511, and a content of the reactive mesogen RM of the second layer 521 may be greater than a content of the reactive mesogen RM of the first layer 511.

Next, referring to FIG. 11, an upper base substrate 130, a color conversion pattern 810 disposed on the upper base substrate 130, an overcoating layer 330 disposed on the color conversion pattern 810, a polarizing element 930 disposed on the overcoating layer 330, and a common electrode 430 disposed on the polarizing element 930 are prepared. Since the upper base substrate 130, the color conversion pattern 810, the overcoating layer 330, the polarizing element 930, the common electrode 430, and other components have been described with reference to FIG. 2 or the like, repetitive descriptions thereof will be omitted.

FIG. 12 is a view illustrating the operation of applying and drying the liquid crystal alignment agent composition on the common electrode 430, and FIG. 13 is an enlarged schematic view of area B1 of FIG. 12. Next, referring to FIGS. 12 and 13, a liquid crystal alignment agent composition 601′ is applied on the common electrode 430, and the liquid crystal alignment agent composition 601′ is dried. The liquid crystal alignment agent composition 601′ may be a composition for forming an upper liquid crystal alignment layer. The liquid crystal alignment agent composition 601′ may include polyamic acid PA as a precursor of the polyimide-based polymer or may include polyimide, and may further include organic-inorganic composite HC and a solvent. The liquid crystal alignment agent composition 601′ for forming an upper liquid crystal alignment layer may be the same as the above-described liquid crystal alignment agent composition for forming a lower liquid crystal alignment layer.

FIG. 14 is a view illustrating the operation of baking the liquid crystal alignment agent composition, and FIG. 15 is an enlarged schematic view of area B2 of FIG. 14. Next, referring to FIGS. 14 and 15, the liquid crystal alignment agent composition is baked and an upper liquid crystal alignment layer 601 is formed. The operation of baking the liquid crystal alignment agent composition may be performed at a temperature of about 160° C. to 180° C. for about 600 seconds to 3,000 seconds. Since the operation of baking the liquid crystal alignment agent composition and forming the upper liquid crystal alignment layer 601 is the same as the operation of forming the lower liquid crystal alignment layer 501, a repetitive description thereof will be omitted.

Next, referring to FIG. 16, a liquid crystal composition is provided between the lower liquid crystal alignment layer 501 and the upper liquid crystal alignment layer 601, and a lower substrate including the pixel electrode 410 and an upper substrate including the common electrode 430 are bonded to form a liquid crystal layer 31.

In an exemplary embodiment, an operation of providing the liquid crystal composition may include an operation of loading the liquid crystal composition on the lower liquid crystal alignment layer 501 and/or the upper liquid crystal alignment layer 601, and an operation of bonding the lower substrate and the upper substrate and forming the liquid crystal layer 31. The operation of bonding the lower substrate and the upper substrate may be performed using a sealing member such as a sealant or the like.

The liquid crystal composition may include liquid crystals 33 having negative dielectric anisotropy. Long axes of the liquid crystals 33 in the liquid crystal layer 31 may be substantially vertically aligned with respect to the plane by the vertically aligned side chains of the polyimide-based polymer of the lower liquid crystal alignment layer 501 and the upper liquid crystal alignment layer 601. Although not illustrated in the drawing, the liquid crystal composition and the liquid crystal layer 31 formed by the liquid crystal composition may further include a reactive mesogen.

FIG. 17 is a view illustrating a first exposure operation, and FIG. 18 is an enlarged schematic view of area A3 of FIG. 17. Next, referring to FIGS. 17 and 18, light is emitted in a state in which an electric field is formed in the liquid crystal layer 31 (hereinafter referred to as a “first exposure operation”). The first exposure operation may be an operation of partially curing the reactive mesogens in above-described the lower liquid crystal alignment layer 501 and upper liquid crystal alignment layer 601 and forming a pretilt in the liquid crystals 33 in the liquid crystal layer 31.

In the case in which the liquid crystals 33 in the liquid crystal layer 31 have negative dielectric anisotropy, when an electric field is formed in the liquid crystal layer 31, the long axes of the liquid crystals 33 may be inclined in a direction crossing a direction of the electric field or the liquid crystals 33 may be rearranged. As the liquid crystals 33 are inclined, the vertically aligned side chains of the polyimide-based polymer PI in the lower liquid crystal alignment layer 501 and the upper liquid crystal alignment layer 601 may be inclined along with the liquid crystals 33. In this state, the reactive mesogens may be polymerized, and the vertically aligned side chains and the liquid crystals 33 may maintain a predetermined pretilt angle even in a state in which the electric field is released. That is, as will be described below with reference to FIG. 19, the liquid crystals 33 may be fixed or stabilized with the pretilt formed by the lower liquid crystal alignment layer 501 and the upper liquid crystal alignment layer 601 even in a state in which the electric field is released in the liquid crystal layer 31.

In an exemplary embodiment, the first exposure operation may be an operation of emitting light from lower side (from a lower substrate 11), that is, the lower liquid crystal alignment layer 501. As illustrated in FIG. 17, an upper substrate 21 includes a first wavelength band filter 730 and a second wavelength band filter 750 which overlap in a third direction Z. When a transmission wavelength band of the first wavelength band filter 730 and a blocking wavelength band of the second wavelength band filter 750 partially overlaps, light transmittance of the upper substrate 21 may be significantly lowered. Therefore, light may be emitted from the lower substrate 11 having a relatively high light transmittance and thus exposure efficiency may be increased. The light may be light having a peak wavelength of about 240 nm to 260 nm, a range of about 270 nm to 280 nm, a range of about 330 nm to 340 nm, or a range of about 360 nm to 370 nm.

Next, referring to FIG. 19, light is emitted in a state in which an electric field is not formed in the liquid crystal layer 31 (hereinafter referred to as a “second exposure operation”). The second exposure operation may be an operation of additionally polymerizing the residual reactive mesogen which is not completely exhausted in the first exposure operation. As the reactive mesogen is substantially completely exhausted by the second exposure operation, the reactive mesogen may be prevented from acting act as an impurity by being dissolved or dispersed in the liquid crystal layer 31.

Although not illustrated in the drawing, a backlight unit may be disposed below the lower base substrate 110 after the second exposure operation to manufacture an LCD.

In the method of manufacturing an LCD according to the present exemplary embodiment, the lower liquid crystal alignment layer 501 and/or the upper liquid crystal alignment layer 601 may be formed using the liquid crystal alignment agent composition including the organic-inorganic composite HC, and thus film hardness of the lower liquid crystal alignment layer 501 and the upper liquid crystal alignment layer 601 may be effectively improved.

In addition, in the process of forming the lower liquid crystal alignment layer 501 and the upper liquid crystal alignment layer 601, thermal damage of other components in the LCD, such as a wavelength shift material 810q of the color conversion pattern 810 or the like, may be prevented by performing baking under a relatively low temperature condition, and the film hardness may be sufficiently ensured by the organic-inorganic composite HC in the lower liquid crystal alignment layer 501 and the upper liquid crystal alignment layer 601 even though the baking is performed under the relatively low temperature condition.

Hereinafter, a method of manufacturing an LCD according to another exemplary embodiment will be described.

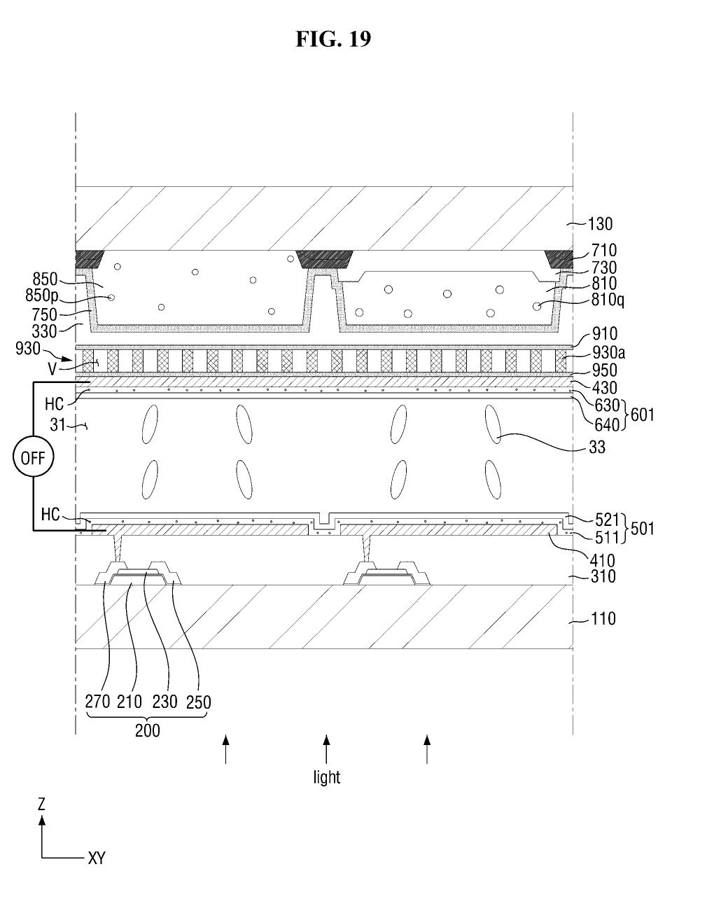

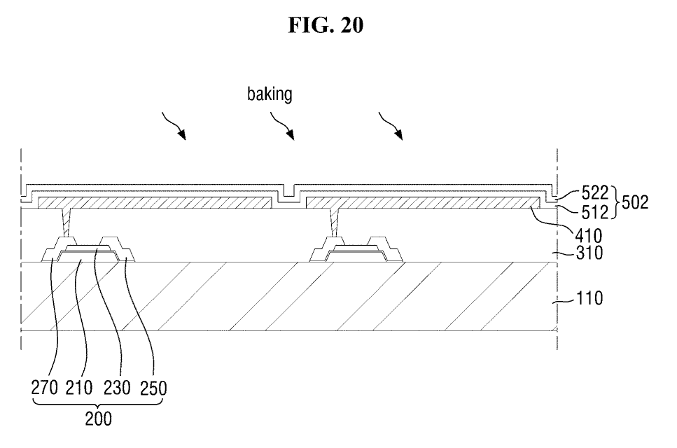

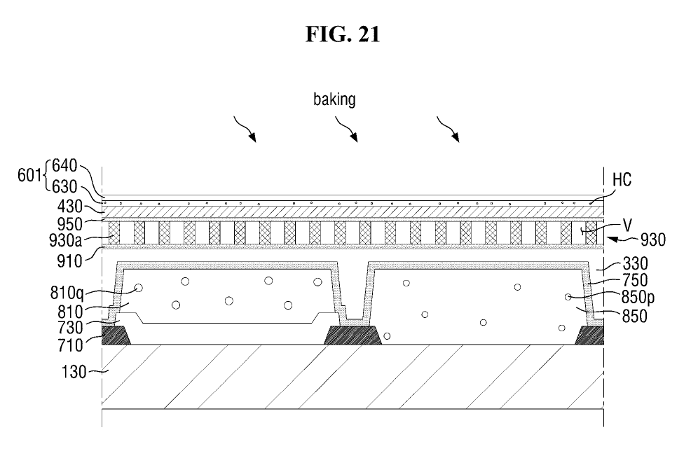

FIG. 20, FIG. 21, FIG. 22, FIG. 23, FIG. 24, and FIG. 25 are views illustrating the method of manufacturing an LCD according to another exemplary embodiment.

First, referring to FIG. 20, a lower base substrate 110, switching elements 200 disposed on the lower base substrate 110, an interlayer 310 disposed on the switching elements 200, pixel electrodes 410 disposed on the interlayer 310, and a lower liquid crystal alignment layer 502 disposed on the pixel electrodes 410 are prepared.

An operation of forming the lower liquid crystal alignment layer 502 may include an operation of applying a liquid crystal alignment agent composition, an operation of drying the liquid crystal alignment agent composition, and an operation of baking the liquid crystal alignment agent composition and forming the lower liquid crystal alignment layer 502.

In an exemplary embodiment, the liquid crystal alignment agent composition may include polyamic acid as a precursor of a polyimide-based polymer or may include polyimide, and may further include a solvent. In FIG. 20, the case in which the lower liquid crystal alignment layer 502 and an alignment agent composition for forming a lower liquid crystal alignment layer do not include an organic-inorganic composite is illustrated. In another exemplary embodiment, the lower liquid crystal alignment layer 502 and the alignment agent composition for forming a lower liquid crystal alignment layer may include an organic-inorganic composite, and a content of the organic-inorganic composite of the lower liquid crystal alignment layer 502 and the alignment agent composition for forming a lower liquid crystal alignment layer may be smaller than a content of organic-inorganic composite of an upper liquid crystal alignment layer 601 and an alignment agent composition for forming an upper liquid crystal alignment layer which will be described below.

The lower liquid crystal alignment layer 502 formed by the alignment agent composition for forming a lower liquid crystal alignment layer being baked may include a polyimide-based polymer. For example, the operation of baking the liquid crystal alignment agent composition may be an operation of dehydrating and cyclizing at least a part of the above-described polyamic acid and forming a polyimide-based polymer. The operation of baking the liquid crystal alignment agent composition may be performed at a temperature of about 160° C. to 180° C. for about 600 seconds to 3,000 seconds. Further, in the operation of baking the liquid crystal alignment agent composition, the liquid crystal alignment agent composition may be phase-separated to form the lower liquid crystal alignment layer 502 including a first layer 512 in contact with the pixel electrode 410 and a second layer 522 located above the first layer 512.

Since the operations of drying and baking the liquid crystal alignment agent composition including polyamic acid, polyimide, and a solvent are described above, repetitive descriptions thereof will be omitted.

Next, referring to FIG. 21, an upper base substrate 130, a color conversion pattern 810 disposed on the upper base substrate 130, an overcoating layer 330 disposed on the color conversion pattern 810, polarizing elements 930 disposed on the overcoating layer 330, a common electrode 430 disposed on the polarizing elements 930, and the upper liquid crystal alignment layer 601 disposed on the common electrode 430 are prepared. The upper liquid crystal alignment layer 601 may include a base made of a polyimide-based polymer and an organic-inorganic composite HC non-uniformly dispersed in the base. A content of the organic-inorganic composite HC in the upper liquid crystal alignment layer 601 may be greater than a content of the organic-inorganic composite HC in the lower liquid crystal alignment layer 502. Since the upper liquid crystal alignment layer 601 including the polyimide-based polymer and the organic-inorganic composite HC has been described above, a repetitive description thereof will be omitted.

Next, referring to FIG. 22, a liquid crystal composition is provided on the lower liquid crystal alignment layer 502 and/or the upper liquid crystal alignment layer 601, and a lower substrate including the pixel electrode 410 and an upper substrate including the common electrode 430 are bonded to form a liquid crystal layer 32.

The liquid crystal composition may include liquid crystals 35a and 35b having negative dielectric anisotropy, and may further include a reactive mesogen RM. The liquid crystal layer 32 may include first liquid crystals 35a adjacent to the lower liquid crystal alignment layer 502 and second liquid crystals 35b adjacent to the upper liquid crystal alignment layer 601.

Long axes of the first liquid crystals 35a and the second liquid crystals 35b in the liquid crystal layer 32 may be substantially vertically aligned with respect to the plane by vertically aligned side chains of the polyimide-based polymer of the lower liquid crystal alignment layer 502 and the upper liquid crystal alignment layer 601. The reactive mesogen RM may be substantially uniformly dispersed in the liquid crystal layer 32.

Next, referring to FIG. 23, light is emitted in a state in which an electric field is formed in the liquid crystal layer 32 (hereinafter referred to as a “first exposure operation”). The first exposure operation may be an operation of partially curing the above-described reactive mesogen RM in the liquid crystal layer 32 and forming pretilts in the first liquid crystals 35a and the second liquid crystals 35b in the liquid crystal layer 32.

When an electric field is formed in the liquid crystal layer 32, the long axes of the first liquid crystals 35a and the second liquid crystals 35b may be inclined in a direction crossing a direction of the electric field or the first liquid crystals 35a and the second liquid crystals 35b may be rearranged. As the first liquid crystals 35a and the second liquid crystals 35b are inclined, the vertically aligned side chains of the polyimide-based polymer in the lower liquid crystal alignment layer 502 and the upper liquid crystal alignment layer 601 may be inclined along with the first liquid crystals 35a and the second liquid crystals 35b. In this state, the reactive mesogens RM are polymerized, and the first liquid crystals 35a and the second liquid crystals 35b may maintain a predetermined pretilt angle even in a state in which the electric field is released.

That is, as will be described below with reference to FIG. 24, the first liquid crystals 35a and the second liquid crystals 35b may be fixed or stabilized with the pretilts formed by the lower liquid crystal alignment layer 502 and the upper liquid crystal alignment layer 601 even in a state in which the electric field is released in the liquid crystal layer 32. The present disclosure is not limited thereto, and, for example, at least a part of the polyimide-based polymer in a third layer 630 of the upper liquid crystal alignment layer 601 may not contribute to initial alignment of the second liquid crystals 35b. Therefore, a degree of contribution of the reactive mesogen RM being polymerized on the upper liquid crystal alignment layer 601 and forming pretilts of the second liquid crystals 35b may be smaller than a degree of contribution of the reactive mesogen RM being polymerized on the lower liquid crystal alignment layer 502 and forming pretilts of the first liquid crystals 35a. In the method of manufacturing an LCD according to the present exemplary embodiment, a difference between the pretilt angles of the first liquid crystals 35a and the second liquid crystals 35b may be generated by only a difference between the contents of the organic-inorganic composite HC without any difference between a process of forming the lower liquid crystal alignment layer 502 and a process of forming the upper liquid crystal alignment layer 601.

Next, referring to FIG. 24, light is emitted in a state in which an electric field is not formed in the liquid crystal layer 32 (hereinafter referred to as a “second exposure operation”). The second exposure operation may be an operation of additionally polymerizing the residual reactive mesogen which is not completely exhausted in the first exposure step. As the reactive mesogen is substantially completely exhausted by the second exposure operation, the reactive mesogen dispersed in the liquid crystal layer 32 may be prevented from acting as an impurity.

Next, referring to FIG. 25, a lower surface of the upper base substrate 130 facing the lower base substrate 110 is convexly bent. In addition, an upper surface of the upper base substrate 130, and an upper surface of the lower base substrate 110 facing the upper base substrate 130 are concavely bent. Accordingly, a curved LCD may be manufactured.

Hereinafter, the present disclosure will be described in more detail with reference to manufacturing examples, comparative examples, and experimental examples.

### Manufacturing Example 1

An LCD panel was manufactured according to the manufacturing method of FIGS. 6 to 19.

A liquid crystal alignment agent composition for forming a lower liquid crystal alignment layer and a liquid crystal alignment agent composition for forming an upper liquid crystal alignment layer were the same composition. In this case, organic-inorganic composite of 0.25 wt % of a total weight of the liquid crystal alignment agent compositions were added. Then, the liquid crystal alignment agent compositions were baked at a temperature of 180° C. and a lower liquid crystal alignment layer and an upper liquid crystal alignment layer were formed.

### Manufacturing Example 2

An LCD panel was manufactured in the same manner as in Manufacturing Example 1 except that organic-inorganic composite of 0.50 wt % of a total weight of a liquid crystal alignment agent composition were added.

### Manufacturing Example 3

An LCD panel was manufactured in the same manner as in Manufacturing Example 1 except that organic-inorganic composite of 1.0 wt % of a total weight of a liquid crystal alignment agent composition were added.

### COMPARATIVE EXAMPLE

An LCD panel was manufactured in the same manner as in Manufacturing Example 1 except that organic-inorganic composite was not added to a liquid crystal alignment agent composition.

### Experimental Example 1: Scratch Simulation Evaluation of Liquid Crystal Alignment Layer

The LCD panels manufactured according to Manufacturing Example 1 and Comparative Example were prepared. Each of the LCD panels was moved downward by about 100 mm by applying pressure downward to the other end of the LCD panel in a gravity direction while one end of the LCD panel was inserted in a fixing jig, so that asymmetric stress was generated on the LCD panel. An operation of applying pressure downward to the other end of the LCD panel and generating stress was repeated 200 times. Then, an operation of inserting the LCD panel upside down to the fixing jig and applying stress was repeated 200 times.

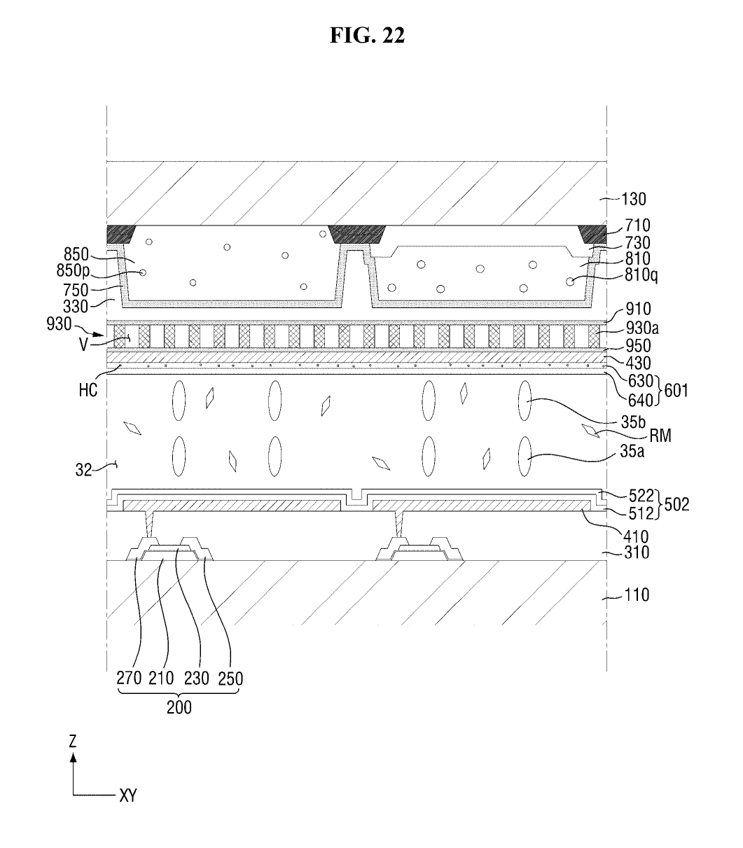

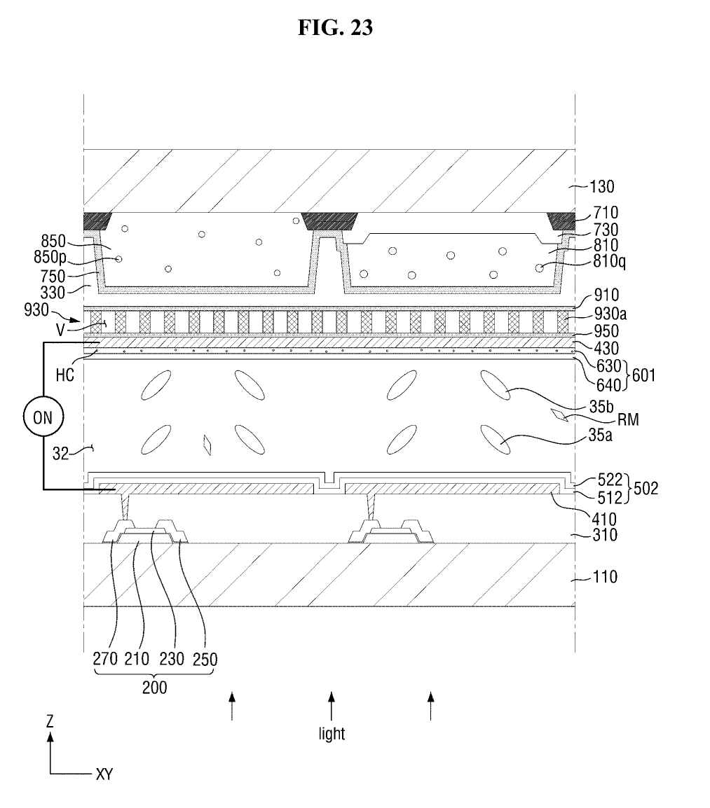

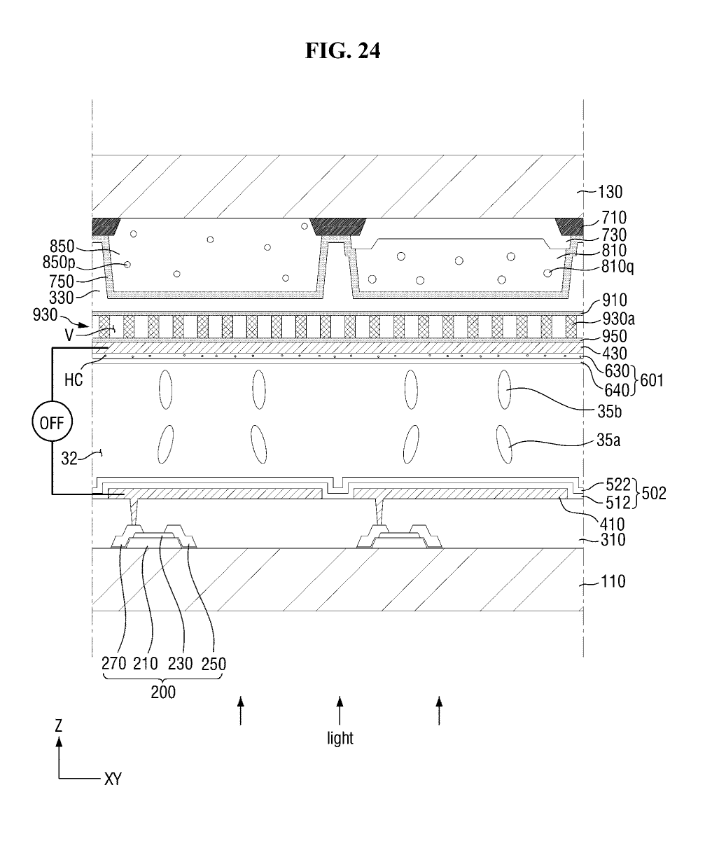

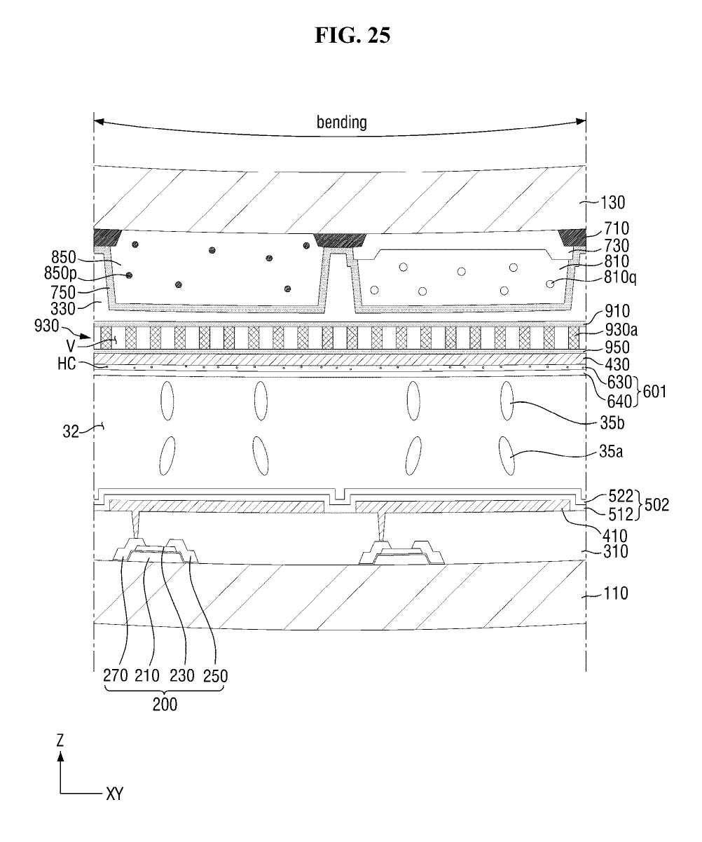

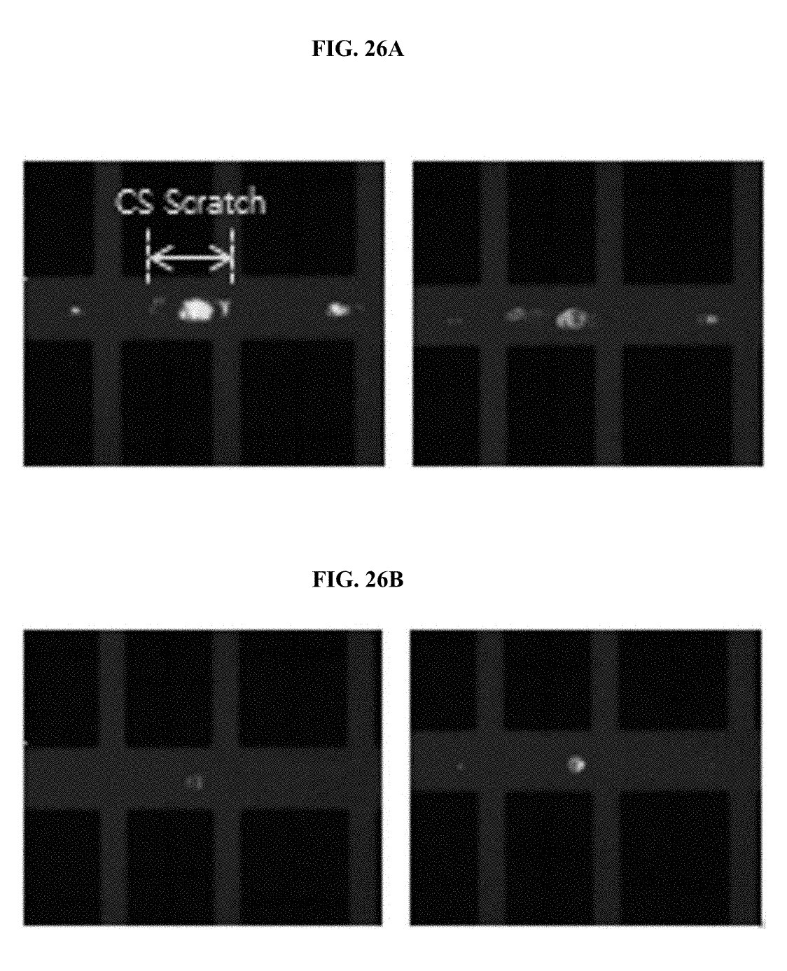

Next, the LCD panels of Manufacturing Example 1 and Comparative Example were disassembled and images of the liquid crystal alignment layers were measured. Results thereof are shown in FIGS. 26A and 26B.

FIG. 26A is a microscopic image of the liquid crystal alignment layer in Comparative Example. Referring to FIG. 26A, it can be confirmed that many dot-shaped scratches were generated on a surface of the liquid crystal alignment layer in Comparative Example. The scratches may be generated due to a column spacer maintaining a cell gap of the liquid crystal layer and abutting the liquid crystal alignment layer, but the present disclosure is not limited thereto.

FIG. 26B is a microscopic image of the liquid crystal alignment layer in Experimental Example 1. Referring to FIG. 26B, it can be confirmed that some scratches were present on a surface of the liquid crystal alignment layer in Manufacturing Example 1 but were significantly reduced in comparison to the scratches generated on the surface of the liquid crystal alignment layer in Comparative Example.

That is, a liquid crystal alignment layer including the organic-inorganic composite had excellent film hardness in comparison to a liquid crystal alignment layer excluding the organic-inorganic composite. Therefore, it can be confirmed that deformation due to stress was minimized even when the same stress was applied under the same condition.

### Experimental Example 2: Measurement of Decomposition Temperature of Liquid Crystal Alignment Layer

The LCD panels according to Manufacturing Examples 1 to 3 and Comparative Example were prepared. Each of the LCD panels was disassembled and a surface of the liquid crystal alignment layer thereof was exposed. Then, each of the LCD panels was inserted in a chamber, a temperature (T_{1%}) at which 1% of the liquid crystal alignment layer was thermally decomposed and a temperature (T_{5%}) at which 5% of the liquid crystal alignment layer was thermally decomposed were measured while a temperature in the chamber was increased, and results thereof are shown in the following Table 1. As the T_{1%} and T_{5%} are increased, thermal stability and film hardness of the liquid crystal alignment layers are excellent.

TABLE 1

| | Manufacturing | Manufacturing | Manufacturing | Comparative |
|---|---|---|---|---|
| | Example 1 | Example 2 | Example 3 | Example |
| T_{1%} | 294.56 | 262.15 | 250.05 | 212.27 |
| (° C.) | | | | |
| T_{5%} | 534.77 | 524.02 | 515.98 | 499.66 |
| (° C.) | | | | |

Referring to the above Table 1, it can be confirmed that the liquid crystal alignment layers including the organic-inorganic composite in Manufacturing Examples 1 to 3 had a significantly higher thermal decomposition temperature than the liquid crystal alignment layer in Comparative Example, and thermal stability and film hardness of the polyimide-based liquid crystal alignment layers were improved.

In the LCD according to the exemplary embodiment, since a liquid crystal alignment layer includes an organic-inorganic composite, high film hardness can be imparted to the liquid crystal alignment layer even though a relatively low temperature process is used, and an LCD having improved display quality and lifetime can be provided.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid-crystal display device, comprising:
a first base substrate;
a first liquid crystal alignment layer disposed on the first base substrate, wherein the first liquid crystal alignment layer comprises a polyimide-based polymer and an organic-inorganic composite; and
a liquid crystal layer disposed on the first liquid crystal alignment layer.

2. The liquid-crystal display device of claim 1, wherein the organic-inorganic composite is organic-inorganic composite particles comprising a layered inorganic substance having a layered structure and an ammonium compound located between layers of the layered inorganic substance.

3. The liquid-crystal display device of claim 2, wherein the ammonium compound comprises an alkyl ammonium salt represented by the following Chemical Formula 2, 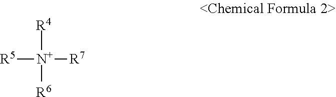
in Chemical Formula 2, each of R⁴ and R⁵ is hydrogen or a methyl group, R⁶ is hydrogen or a linear-chain or branched-chain alkyl group having a carbon number of 12 to 20, and R⁷ is a linear-chain or branched-chain alkyl group having a carbon number of 12 to 20.

4. The liquid-crystal display device of claim 3, wherein:
the alkyl ammonium salt represented by Chemical Formula 2 is an alkyl ammonium salt represented by the following Chemical Formula 2A or an alkyl ammonium salt represented by the following Chemical Formula 2B; and
a content of the alkyl ammonium salt represented by the following Chemical Formula 2 Å is greater than a content of the alkyl ammonium salt represented by the following Chemical Formula 2B, 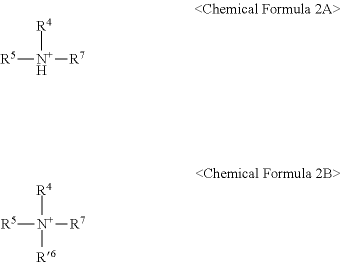
in the above Chemical Formula 2A and Chemical Formula 2B, R⁴, R⁵, and R⁷ are the same as those defined in the above Chemical Formula 2, and R′⁶ is a linear-chain or branched-chain alkyl group having a carbon number of 12 to 20.

5. The liquid-crystal display device of claim 3, wherein the alkyl ammonium salt represented by the above Chemical Formula 2 comprises:
a tetradecyl ammonium salt in which R⁷ is a tetradecyl group;
a hexadecyl ammonium salt in which R⁷ is a hexadecyl group; and
an octadecyl ammonium salt in which R⁷ is an octadecyl group, and
wherein a content of the octadecyl ammonium salt is greater than a sum of a content of the tetradecyl ammonium salt and a content of the hexadecyl ammonium salt.

6. The liquid-crystal display device of claim 2, wherein:
the polyimide-based polymer comprises a main chain having a imide group and a vertically aligned side chain bonded to the main chain; and
at least a part of the main chain of the polyimide-based polymer is located between the layers of the layered inorganic substance.

7. The liquid-crystal display device of claim 2, wherein:
the ammonium compound includes alkyl ammonium; and
at least a part of the polyimide-based polymer forms a structure entangled with an alkyl group of the alkyl ammonium.

8. The liquid-crystal display device of claim 1, wherein a content of the organic-inorganic composite in the first liquid crystal alignment layer is partially non-uniform.

9. The liquid-crystal display device of claim 8, further comprising a common electrode disposed between the first base substrate and the first liquid crystal alignment layer,
wherein the first liquid crystal alignment layer includes a first layer in contact with the common electrode and a second layer in contact with the liquid crystal layer, and
a content of organic-inorganic composite in the first layer is greater than a content of organic-inorganic composite in the second layer.

10. The liquid-crystal display device of claim 8, further comprising:
a second liquid crystal alignment layer disposed on the liquid crystal layer;
a pixel electrode disposed on the second liquid crystal alignment layer;
a second base substrate disposed on the pixel electrode; and
a backlight unit disposed on the second base substrate,
wherein one surface of the second base substrate facing the backlight unit is convexly bent, and
wherein the second liquid crystal alignment layer does not include the organic-inorganic composite, or
wherein a content of organic-inorganic composite in the second liquid crystal alignment layer is smaller than the content of the organic-inorganic composite in the first liquid crystal alignment layer.

11. A method of manufacturing a liquid-crystal display device, the method comprising:
forming a first liquid crystal alignment layer comprising a polyimide-based polymer and an organic-inorganic composite on a first base substrate; and
forming a liquid crystal layer on the first liquid crystal alignment layer.

12. The method of claim 11, wherein the organic-inorganic composite is organic-inorganic composite particles comprising a layered inorganic substance having a layered structure and an ammonium compound located between layers of the layered inorganic substance.

13. The method of claim 12, wherein the forming of the first liquid crystal alignment layer comprises:
applying a liquid crystal alignment agent composition to the first base substrate; and
baking the liquid crystal alignment agent composition at a temperature of 160° C. to 180° C.

14. The method of claim 13, wherein the liquid crystal alignment agent composition comprises a polyamic acid or a polyimide, and the organic-inorganic composite particles.

15. The method of claim 14, wherein:
in the baking of the liquid crystal alignment agent composition, at least a part of the polyamic acid is dehydrated and cyclized to form a polyimide-based polymer; and
in the baking of the liquid crystal alignment agent composition, at least a part of a main chain of the polyimide-based polymer is inserted between the layers of the layered inorganic substance and stabilized.

16. The method of claim 14, wherein a content of the organic-inorganic composite particles ranges from 0.1 wt % to 2.0 wt % with respect to a total weight of the liquid crystal alignment agent composition.

17. The method of claim 13, wherein, in the baking of the liquid crystal alignment agent composition, the liquid crystal alignment agent composition is phase-separated into a first layer including the organic-inorganic composite particles and a second layer disposed on the first layer and having a smaller content of organic-inorganic composite particles than the first layer.

18. The method of claim 11, further comprising, after the forming of the liquid crystal layer:
a first exposure operation of emitting ultraviolet rays to the liquid crystal layer in a state in which an electric field is formed in the liquid crystal layer; and
a second exposure operation of emitting ultraviolet rays to the liquid crystal layer in a state in which an electric field is not formed in the liquid crystal layer.

19. The method of claim 11, further comprising, before the forming of the liquid crystal layer:
preparing a second base substrate; and
forming a second liquid crystal alignment layer comprising a polyimide-based polymer on the second base substrate,
wherein the forming of the liquid crystal layer is an operation of forming the liquid crystal layer between the first liquid crystal alignment layer and the second liquid crystal alignment layer.

20. The method of claim 19, wherein:
the second liquid crystal alignment layer does not include the organic-inorganic composite; or
a content of organic-inorganic composite in the second liquid crystal alignment layer is smaller than a content of the organic-inorganic composite in the first liquid crystal alignment layer, and
the method further comprises convexly bending one surface of the first base substrate facing the second base substrate.
